(19) United States
(12) Patent Application Publication
(10) Pub. No.: US 2025/0136814 A1
(43) Pub. Date: May 1, 2025

(54) BINDER COMPONENT FOR A FEEDSTOCK COMPOUND FOR USE IN A SHAPING AND SINTERING PROCESS, PARTICULATE FEEDSTOCK COMPOUND, AND SHAPING AND SINTERING PROCESS

(71) Applicant: Headmade Materials GmbH, Unterpleichfeld (DE)

(72) Inventors: Christian STAUDIGEL, Unterpleichfeld (DE); Christian FISCHER, Unterpleichfeld (DE)

(21) Appl. No.: 18/683,420

(22) PCT Filed: Aug. 19, 2022
(86) PCT No.: PCT/EP2022/073220

§ 371 Date: Feb. 13, 2024

(30) Foreign Application Priority Data
Aug. 19, 2021 (EP) 21192103.6

(51) Int. Cl. C08L 91/06; B22F 10/16; C04B 35/634

(52) U.S. Cl. CPC C08L 91/06; C04B 35/63468; B22F 10/16

(57) ABSTRACT

A binder component for a feedstock compound for use in a shaping and sintering process comprises b-i) 3 to 70% by volume of at least one first thermoplastic and/or wax-type material, and b-ii) 30 to 97% by volume of at least one second thermoplastic and/or wax-type material, based on the total volume of the binder component b). The first thermoplastic and/or wax-type material and the second thermoplastic and/or wax-type material differ in at least one property which property is selected from (1) solubility in a solvent, (2) degradability induced by heat and/or a reactant, and (3) volatility. The first thermoplastic and/or wax-type material is less soluble, less degradable or less volatile than the second thermoplastic and/or wax-type material. T_{cross} is higher by not more than 60 K than T_{P}, wherein T_{P} is the DSC melt peak temperature of the binder component b), and T_{cross} is the temperature at the intersection between the storage modulus G′ curve and the loss modulus G″ curve in a dynamic viscoelasticity measurement of the binder component b). The feedstock compound containing the binder component and non-organic sinterable particles is used in an additive manufacturing process, an injection molding process, a pressing process or a casting process.

The present invention relates to a binder component for a feedstock compound for use in a shaping and sintering process, a particulate feedstock compound comprising sinterable non-organic particles and the binder component, and a process comprising the steps of merging a plurality of particulate feedstock compounds and debinding.

Processes such as additive manufacturing, powder injection molding or pressing allow for the generation of customized parts in a quick and efficient way. Additive manufacturing involves material being added together such as powder grains being fused together, typically layer by layer. Generally, a typical additive manufacturing process comprises the steps of forming a first material-layer, and successively adding further material-layers thereafter, wherein each new material-layer is added on a pre-formed material-layer, until the entire three-dimensional structure (3D object) is materialized.

Powder injection molding involves material being molten and injected in a mold to form an object. Especially, a low pressure powder injection molding (LPIM) process needs moderate processing temperature and pressure for these steps.

In Laser Beam Powder Bed Fusion (LB-PBF), powdered metal which is free of binder is sintered by the scanning of a high-power laser beam. To dispense with the necessity of high-power lasers, binder-coated metal powders were shaped by additive manufacturing. In a post-processing step, the binder is removed and the metal powder sintered.

All of these novel processes require well-defined feedstock compounds comprising a sinterable material and a binder. Recently, a variety of such feedstock compounds was described in the literature. WO 95/30503 describes a powder for use in a selective laser sintering process comprising a (metal) substrate coated with a polymeric binder. The binder comprises an amorphous copolymer of, for example, butyl methacrylate and styrene, or methyl methacrylate and butyl methacrylate. Optionally, the binder may further comprise a plasticizer which is not described in further detail.

DE 196 48 926 C1 describes parts consisting of pulverulent particles which comprise metal particles such as Fe, Co, Ni, W, Mo, or metal carbides. The particles are connected via a mixture of a polyamide and a plasticizer/wax mixture which is not described in further detail.

In US 20190134712 A1, a low-pressure powder injection molding machine, a kit and a method thereof is described. Low-pressure powder injection molding (LPIM) is a variant of the conventional high-pressure powder injection molding (HPIM) process in which recent progress in feedstock formulations has generated new opportunities for producing shapes of higher complexity that is yet cost-effective, either in high or in low production volumes. A pneumatic molding machine is generally used to fill a mold cavity with a powder-binder mixture.

Recently, Tafti et al. described the effect of thermal debinding conditions on the sintered density of low-pressure powder injection molded iron parts (see Metals 2021, 11, 264-276). Therefore, a low viscosity feedstock was injected into a rectangular mold cavity, thermally debound at three different debinding temperatures and sintered. By increasing the debinding temperature from 600 to 850° C., the number of fine particles decreased resulting in a decreasing (sintered) density (6.2 to 5.1 g/cm³) and thus an increasing average pore size (9 to 14 μm). Also the pore circularity decreased (67 to 59%).

According to Tafti et al. (see above), in conventional HPIM processes, the binder, which consists of a blend of low- and high-molecular-weight polymers (also called primary and secondary binders, respectively), is removed in two steps. During the first step, the primary binder is extracted either by a solvent, a supercritical fluid such as supercritical carbon dioxide, or a catalyst such as highly concentrated nitric acid, depending on the binder system and powder characteristics. During the second step, the secondary binder, acting as a backbone to retain the shape, is removed during a final burnout cycle before the sintering process.

Generally, in LPIM, multi-component binders which do not contain a high melting point backbone polymer, are used. For example, said multi-component binders may comprise wax-based carriers, surfactants, and thickening agents.

However, in the absence of a backbone binder, one of the main challenges encountered in the LPIM process is shape retention and lack of brown part strength since all the binder components are removed in a single step during debinding, e.g. during thermal wick debinding. Said thermal wick debinding process relies on capillary extraction of the liquid binder to extract the binder from the green part. The approach consists of embedding the injected parts into a wicking powder bed (e.g. graphite, alumina, or further inert powders) and to heat it to a pre-sintering temperature (e.g. to the softening temperature of the binder), if necessary in a protective atmosphere. The powder bed acts as a wicking medium to withdraw the molten binder out of the heated part by capillary flow. As physical support, it maintains the weak debound part up to the pre-sintering of powder particles. In thermal wick debinding, critical parameters such as wicking medium pore size, debinding temperature, heating rate, protective atmosphere, or pre-sintering temperature must be carefully selected in order to ensure proper binder extraction, while simultaneously avoiding disadvantages such as undesirable stresses, distortions, defects or chemical reactions. However, the use of fine powders may result in contamination of the green part, which may require further cleaning.

For example, US 2003/0161751 A1 discloses a composite comprising tungsten and bronze. In order to form a homogeneous mixture, tungsten and bronze powders (non-organic particles) are blended with an organic binder. As organic binder, generally a thermoplastic binder, a wax or blend of waxes is preferred. The preferred binder comprises a low molecular weight wax or wax blend that preferably melts at a temperature from about room temperature to about 120° C., more preferably from about 50 to 90° C., yet more preferably from about 55 to 65° C. For example, the wax may be paraffin wax, microcrystalline wax, polybutene wax, polyethylene wax, Carnauba wax etc., or a blend of two or more thereof. The thermal debinding step involves heating of the shaped part in a furnace to a temperature that rapidly transforms the binder by pyrolysis into gaseous products that are swept away by a flowing protective atmosphere. As the part is heated, the binder melts. A wicking powder, for example a powder comprising alumina, may be used to create a capillary force gradient that draws the binder out of the part.

WO 2016004985 A1 describes filaments comprising a metal and/or ceramic powder, a thermoplastic binder comprising a thermoplastic polymer and at least one plasticizer, and, optionally, additives. Suitable thermoplastic polymers described therein are, for example, polyurethanes, polyamides, polyvinylpyrroli-dons, polyacrylates, or polyolefins and suitable plasticizers are selected from aromatic or heteroaromatic carboxylic acid esters such as hydroxybenzoic acid esters.

WO 2016/004985 discloses filaments suitable to be used in a 3D printing device, wherein the filament comprises or consists of a metal and/or ceramic powder, a thermoplastic binder comprising a thermoplastic polymer and at least one plasticizer, and optionally additives. Further, a process for producing a shaped body comprising the filaments described above is disclosed, the shaped body is obtained by printing a shaped green body using the filaments, removing at least one part of the plasticizer and sintering.

Recently, a process was described for the manufacture of a metallic and/or vitreous and/or ceramic component by additive manufacturing. WO 2018/197082 discloses a method for additively manufacturing a metal and/or glass-type and/or ceramic component. Feedstock compound particles are prepared from substrate particles and an at least two-phase binder. The feedstock compound particles are molten selectively in layers by means of electromagnetic radiation, such that a molded part is additively manufactured. The molded part is removed from the unmelted mixture, and the at least two-phase binder is then successively removed. Finally, the debound molded part is sintered.

However, different factors during the printing process may compromise the dimensional accuracy of the part relative to the object data that defines it. For example, it is often difficult to manufacture (green) parts having sharp and accurate edges and having a low porosity. Also, improvements in the shaping step should not result in disadvantages or deteriorations in the debinding step.

It is therefore an object of the present invention to provide a binder component for a feedstock compound which allows for high dimensional printing accuracy and a simple and economical way of debinding in a process employing the feedstock compound containing the binder component.

The invention relates to a binder component for a feedstock compound for use in a shaping and sintering process comprising, based on the total volume of the binder component (b),
b-i) 3 to 70% by volume of at least one first thermoplastic and/or wax-type material,
b-li) 30 to 97% by volume of at least one second thermoplastic and/or wax-type material or a plasticized thermoplastic and/or wax-type material,
   wherein the first thermoplastic and/or wax-type material and the second thermoplastic and/or wax-type material differ in at least one property which property is selected from
(1) solubility in a solvent,
(2) degradability induced by heat and/or a reactant, and
(3) volatility,
wherein the first thermoplastic and/or wax-type material is less soluble, less degradable or less volatile than the second thermoplastic and/or wax-type material,
wherein T_{cross} is higher by not more than 60 K than T_{P}, wherein
T_{P} is the DSC melt peak temperature of the binder component (b), and
T_{cross} is the temperature at the intersection between the storage modulus G′ curve and the loss modulus G″ curve in a dynamic viscoelasticity measurement of the binder component (b).

Hereinafter, the expression “(plasticized) thermoplastic and/or wax-type material” is intended to encompass both “thermoplastic and/or wax-type material” and “plasticized thermoplastic and/or wax-type material”.

The invention also relates to a particulate feedstock compound for use in a shaping and sintering process, containing
a) sinterable non-organic particles dispersed throughout the particulate feedstock compound, the sinterable non-organic particles having a particle size distribution such that at least 80% of the particles have a maximum particle size Aₘₐₓ in the range of 100 nm to 200 μm; and
b) the binder component (b).

The invention also relates to a process comprising the steps of merging a plurality of the particulate feedstock compounds and debinding.

The following description of preferred embodiments refers to the binder component, the particulate feedstock compound and the process, unless noted otherwise.

Generally, the shaping step of additive manufacturing processes involves providing a powder bed of a particulate feedstock compound in a construction space which is usually heated to an elevated temperature, e.g. to 50 to 60° C. The particulate feedstock compound in the powder bed can absorb the energy from, e.g., an energy beam from a radiation source, such as a laser beam, and, and as a result, a localized region of the powder material increases in temperature. The local increase in temperature allows for selectively densifying or melting the particulate feedstock compound to bind the particulate feedstock compound to each other in a predefined manner.

It has been found that the melting behavior of the binder has a strong influence on the printing accuracy. While it is desirable that within the localized region a strong bond is formed between the particulate feedstock compound, formation of bonds to adjacent or neighboring particles should be avoided. Feedstock compounds with a non-optimized binder component may dissipate heat to adjacent particles which can soften and adhere to the outside surface of the part, resulting in poor surface definition.

In powder injection molding, the particulate feedstock is molten by a heated barrel and/or screw and injected in a mold by a plunger or pressure or gravity. Likewise, it has been found that the melting behavior has a strong influence on the processing parameters in powder injection molding. A low viscosity of the feedstock compound allows to reduce the size of the injection machines and the overall size of the molds, both are significantly smaller than those required for HPIM. The lower costs associated with smaller tooling offer an opportunity to fabricate intricate parts in a cost-effective way, whether in low or in high production volumes. Moreover, due to the easy moldability and better flowability of the feedstock compound, larger parts can be produced than by HPIM.

For the binder components of the invention, the temperature transition from solid or semi-solid to fluid is very narrow, leading to less influence on adjacent feedstock compound particles in 3D printing. As a result, the feedstock compound particles irradiated with an energy beam can be converted from solid to fluid at comparably low temperature and form a dense green part without affecting adjacent feedstock compounds. This narrow temperature transition from solid or semi-solid to fluid is reflected by a small difference between T_{P} and T_{cross} as explained in more detail below.

Generally, differential scanning calorimetry (DSC) allows for the determination of physical properties of a material, e.g. glass transition temperature, melting temperature, melting enthalpy etc.

The melting process results in an endothermic peak in the DSC curve and the melting temperature refers to the melt peak temperature T_{P} in said DSC curve where the rate of change of endothermic heat flow is maximum.

The DSC curve may comprise a single melt peak. Alternatively, the DSC curve may comprise several melt peaks, i.e. several local maxima. For the purposes herein, the melt peak temperature T_{P} is defined as the temperature at the global maximum. The binder component (b) preferably exhibits a single melt peak.

In an embodiment, the binder component (b) exhibits a melt peak temperature T_{P} below 180° C., preferably in the range of 10° C. to 180° C., more preferably 20° C. to 160° C., most preferably 30° C. to 140° C., in particular 35° C. to 120° C., in particular 40° C. to 100° C., in particular 45° C. to 90° C., in particular 50° C. to 85° C. Melt peak temperatures T_{P} within these ranges allow for selective densifying or melting with as little additional energy (e.g. laser energy) as possible, and low energy laser sources can conveniently be used.

Herein, T_{P} is determined in accordance with DIN EN ISO 11357-3 in the second heating after a first heating/cooling cycle. For this purpose, a sample is heated in a first heat ramp from −20° C. to a temperature which is 20 K above completion of all thermal events, cooled to −20° C. afterwards and finally heated again in a second heat ramp from −20° C. to the temperature which is 20 K above completion of all thermal events, each with a heating and cooling rate of 10 K/min. “Thermal events” for the purpose herein means thermal events other than decomposition, or in other words, essentially reversible thermal events.

Generally, dynamic viscoelasticity measurements allow for the determination of dynamic viscoelasticity properties including storage modulus G′ and loss modulus G″ of a material.

The storage modulus G′ represents the elastic proportion of a material. It is proportional to the proportion of deformation energy which is stored in the material and which may be recovered from the material after relief of stress.

The loss modulus G″ represents the viscous portion of a material. It corresponds to the proportion of energy loss which is converted into heat by internal friction.

T_{cross} is the temperature at the intersection between the storage modulus G′ curve and the loss modulus G″ curve in a dynamic viscoelasticity measurement of the binder component. This temperature is also referred to as “cross-over” temperature in the literature and refers to a state of the material at which the transition from the molten state to the viscous state of said material takes place. If the G′ and the G″ curves intersect more than once, T_{cross} is the intersection at the highest temperature. It is understood by the skilled person that the expression “highest temperature” refers to the highest temperature below a temperature where decomposition occurs.

A sample of the binder component (b) is subjected to dynamic viscoelasticity measurement.

In principle, T_{cross} may be determined in a heating step or a cooling step. Kinetic effects, such as supercooling or suspended thermal transitions, may interfere with the determination of T_{cross}. To eliminate the influence of kinetic effects, it may be advisable to determine T_{cross} in a heating step or a cooling step. In the event that T_{cross} measured during heating differs from T_{cross} measured during cooling, the higher value of T_{cross} is used.

Due to non-equilibrium transitions that can occur during measurement of the binder, the measurement of the feedstock compound may yield in more accurate result in individual instances. It is contemplated that kinetic effects are less likely to occur when the feedstock compound is subjected to measurement because the non-organic particles (a) may act as crystallization nuclei and reduce diffusive processes.

For example, the storage modulus G′ curve and the loss modulus G″ curve are recorded in a dynamic viscoelasticity measurement during heating of a material starting from a temperature below its melting temperature, e.g. 20 K below T_{P} to a temperature where the material is completely molten.

First, it was cooled from 110° C. to 60° C., then heated to 110° C., each with a cooling and heating rate of 1 K/min.

In the context of the present patent application, dynamic viscoelasticity measurements to determine storage modulus and loss modulus are performed in accordance with DIN 53019-4:2016-10. The measurements are suitably performed with a plate-plate geometry with a diameter of 40 mm and a frequency of 1 Hz in oscillation mode. The measuring gap may be 0.15 mm.

For carrying out the measurement, the geometry is heated to a temperature at which the sample of binder component (b) is fully liquefied, i.e. a temperature of about 20 K above the presumed T_{cross} of the binder component (b), and the sample is placed on the hot lower plate. First, it is cooled from the temperature of about 20 K above T_{cross} of the binder component (b) to a temperature of about 10 K below the first intersection temperature, then heated to the temperature of about 20 K above the melting temperature of the binder component (b), each with a cooling and heating rate of 1 K/min.

In the cooling ramp, the measurement is started in deformation controlled mode with a constant deformation γ=0.1%. After reaching a trigger point, the measurement is switched to shear stress controlled mode with a constant shear stress (α=100 Pa for the binder, α=700 Pa for the feedstock compound). In the heating ramp, the measurement is started in shear stress controlled mode with a constant shear stress of α=300 Pa. After reaching a trigger point, the measurement is switched to deformation controlled mode with a constant deformation γ=0.1%. The trigger point is located in the transition between the solid and the liquid state. Between both states, the shear modulus changes significantly which results in the necessity of different control modes in the measurement needs.

As the specimen undergoes a phase transformation during the heating or cooling ramp, a change of the measurement mode is necessary to stay in the linear viscoelastic range. For example, during the cooling ramp, the specimen changes from a liquid to a rigid state. The deformation in the liquid state must not be too large, otherwise the specimen is no longer in the linear viscoelastic range. If the liquid is exposed to a certain deformation, upon releasing the imposing force or stress, the liquid completely takes the new shape or position. Since the specimen will reach the selected deformation in the liquid state, the measurement in this phase is deformation controlled. In the rigid state, the deformation would not be achieved and the limit of the torque of the rheometer will be reached. That is why measuring mode has to be switched to shear stress controlled mode. The switch of the measurement of deformation controlled mode to shear stress controlled mode is set by a trigger point. The trigger point is located in the transition between the solid and the liquid state. Between both states, the shear modulus changes significantly which results in the necessity of different control modes in the measurement needs. The trigger point can be any specific point or criteria that allows the change of measuring mode in the linear viscoelastic range. In the heating ramp, it is the same way round.

According to the invention, the binder component satisfies a condition such that T_{cross} is higher by not more than 60 K than T_{P}, preferably by not more than 50 K, more preferably by not more than 45 K, most preferably by not more than 40 K, in particular by not more than 35 K. This also includes a situation where T_{cross} is lower than T_{P}.

In an embodiment, the binder component (b) exhibits a percentage of melting enthalpy measured by DSC between Tᵢₙᵢₜ and [T_{P}+25 K], of at least 94%, preferably at least 95%, more preferably at least 96%, most preferably at least 97%, in particular at least 98%, in particular at least 99% of the total melting enthalpy, wherein Tᵢₙᵢₜ is the initial melting temperature. The term “total melting enthalpy” refers to the sum of any endothermic DSC peaks in the range of 10° C. to 20 K above completion of all thermal events, for example in the range of 10° C. to 200° C. Melting enthalpy is usually reported as J/g and can be derived from the area which is enclosed by an endothermic DSC peak curve and the baseline.

For evaluation, the part of the curve after complete melting was rotated to horizontal. The base line was drawn horizontally from the end of the thermogram. The initial melting temperature (Tᵢₙᵢₜ) is the first cross-over point between the baseline and the thermogram at a temperature below T_{P} and refers to the initial melting temperature of the binder component (b). The melting temperature T_{P} is the temperature at maximum height of the peak.

Either a sample of the binder component (b), this is without sinterable non-organic particles (a), or a sample of the feedstock compound, this is the binder component (b) containing sinterable non-organic particles (a), is subjected to DSC measurements. As the sinterable non-organic particles (a) do not exhibit a phase transition in the temperature range of the DSC measurement, the general shape of the DSC curve as well as the melt peak temperature essentially remain unchanged. For the measurement of the sample containing the binder component (b) and the sinterable non-organic particles (a), the absolute peak area differs compared to the measurement of the sample containing only the binder component (b). This is due to the “dilution” of the sample by the sinterable non-organic particles (a). However, since the ratios are expressed as percentage values, the result remains essentially unchanged.

According to the invention, the first thermoplastic and/or wax-type material (b-i) and the second thermoplastic and/or wax-type material (b-li) differ in at least one property which property is selected from
(1) solubility in a solvent, preferably selected from alcohols such as ethanol, or propanol; aromatic compounds such as benzene, toluene, or xylene; esters such as ethyl acetate; ethers such as diethylether, or tetrahydrofuran; ketones such as acetone; alkanes such as hexane, or heptane; halogenated hydrocarbons such as n-propyl bromide, trichloroethylene, perchloroethylene, n-methyl pyrrolidine; and mixtures thereof; water; and gases in supercritical state; and
(2) degradability induced by heat and/or a reactant, preferably nitric acid,
(3) volatility, e.g. by evaporation induced by temperature and/or reduced pressure,
wherein the first thermoplastic and/or wax-type material (b-i) is less soluble, less degradable, or less volatile than the second thermoplastic and/or wax-type material (b-li).

The binder component (b) comprises 3 to 70% by volume, preferably 5 to 60% by volume, more preferably 7 to 50% by volume, most preferably 10 to 40% by volume, in particular 12 to 35% by volume, in particular 15 to 30% by volume, of the first thermoplastic and/or wax-type material (b-i), based on the total volume of the binder component (b).

The binder component (b) further comprises 30 to 97% by volume, preferably 40 to 95% by volume, more preferably 50 to 93% by volume, most preferably 60 to 90% by volume, in particular 65 to 88% by volume, in particular 70 to 85% by volume, of a second (plasticized) thermoplastic and/or wax-type material (b-li), based on the total volume of the binder component (b).

Different solubility or degradability or different volatility allows for selective debinding. In the selective debinding step, one binder component is removed (in the context of the present patent application: the second thermoplastic and/or wax-type material (b-li)) wherein at the same time another binder component (the first thermoplastic and/or wax-type material (b-i)) remains within the part to be manufactured, holding together the sinterable non-organic particles. Such debinding processes, e.g. solvent debinding, thermal debinding, chemical debinding etc., are known per se.

The present invention uses partial debinding such as thermal debinding, solvent debinding or chemical debinding and thus avoids the disadvantages which are associated with processes that rely on wicking processes.

In embodiments which are especially suitable for small parts, exclusively thermal debinding can take place without the necessity of wicking processes. During such wicking processes, the whole amount of binder softens in a small temperature range and the part needs to be supported by a wicking powder in order to prevent shape loss or distortion. This makes the process time consuming and limits the design freedom of the part. Further, the use of fine powders may result in contamination of the green part, which may require further cleaning. The method according to the invention involves the removal of the second thermoplastic and/or wax-type material (b-li) progressively from the part by degradation and/or evaporation, wherein the first thermoplastic and/or wax-type material (b-i) is affected as little as possible.

In an embodiment, also the disadvantages which are associated with processes that exclusively rely on thermal debinding are avoided, especially for larger parts. During thermal debinding of the second thermoplastic and/or wax-type material, as the temperature rises, increasing amounts of binder evaporate from the entire binder mass. Sudden evaporation of a binder fraction with no clear exit path my cause the part to rupture and lose integrity. Hence, the evaporation rate of the binder must be extremely slow to prevent part rupture, so degradation rate has to be kept low. This makes thermal debinding of the second thermoplastic and/or wax-type material a difficult and time consuming process, especially for bigger parts. The method according to the invention involves removal of the second thermoplastic and/or wax-type material progressively from the outside of the part to the core, in such a manner that the first thermoplastic and/or wax-type material is affected as little as possible, i.e. by solvent debinding and chemical debinding.

Suitably, in the solvent debinding process, one binder component may be selectively removed from a green part by means of dissolving said binder component in a solvent, wherein a second binder component remains within the green part. Therefore, the binder components need to differ in e.g. molecular weight or polarity in order to exhibit different solubilities in the solvent.

Any given polymer or wax may be fairly soluble in one solvent, e.g., a non-polar solvent, and may be poorly soluble or insoluble in another solvent, e.g., a more polar solvent. Hence, whether a given polymer or wax qualifies as a (b-i) or (b-ii) material depends on the solvent intended for the debinding step. When changing solvents, e.g. from polar solvents to less polar or non-polar solvents or vice versa, the categorization of the binder components into (b-i) or (b-li) may be reversed.

For example, in the event that solvent debinding is performed using acetone as a solvent, the material remaining in the part to be debound (the first thermoplastic and/or wax-type material (b-i)) may be a polymer or wax which is poorly soluble or insoluble in acetone, whereas binder component to be removed (the second thermoplastic and/or wax-type material (b-li)) may be a polymer or wax which is soluble in acetone.

In an embodiment, solubility of the first thermoplastic and/or wax-type material (b-i) is lower than 0.1 g, preferably lower than 0.05 g, more preferably lower than 0.01 g, most preferably lower than 0.005 g in 100° g solvent, in particular insoluble in the solvent, and the solubility of the second thermoplastic and/or wax-type material (b-li) is in the range of 0.1 g to 500 g, preferably 0.5 g to 300 g, more preferably 1 g to 200 g, most preferably 2 g to 175 g, in particular 3 g to 150 g, in particular 5 g to 100 g, in 100 g solvent at a predetermined temperature. The predetermined temperature may be in the range of 10° C. to [T_{P}−5° K], preferably 20° C. to 80° C., more preferably 30° C. to 70° C., most preferably 35° C. to 65° C., in particular 40° C. to 60° C.

A chemical debinding (also referred to as “catalytic debinding”) process is e.g. described in DE 10 2005 027 216 A1. For this purpose, a molded article to be debound is positioned in a debinding furnace in which the molded article is brought to an appropriate process temperature. Afterwards, a process gas which includes a reactant (such as nitric acid) is introduced into the furnace. By contacting the molded part which comprises the binder with said reactant at elevated temperatures, binder components may be removed by burning them out of the molded part, wherein one or more binder components may remain in the molded article depending on their chemical stability towards the reactant.

In an embodiment, the first thermoplastic and/or wax-type material (b-i) is semi-crystalline. The term “semi-crystalline” characterizes those polymers which possess high degrees of inter- and intra-molecular order. The semi-crystalline nature of a polymer can be verified by a first order transition or crystalline melting point (Tₘ) as determined by differential scanning calorimetry (DSC).

Preferably, the first thermoplastic and/or wax-type materials (b-i) is semi-crystalline because they exhibit a sharp transition separating the fluid and solidified states. Further, they are characterized by a strength increase by crystallization upon solidification.

The first thermoplastic and/or wax-type material (b-i) and the second thermoplastic and/or wax-type material (b-li) may be selected from a variety of materials.

Suitable polymers include:
polyolefins such as
polyethylene such as Lupolen 2420, Lupolen 5261 Z (available from LyondellBasell Industries Holdings B.V.), Sabic P6006NA (available from Sabic), BorPure® MB5569, BorPure® MB6561, BorPure® MB7541 (available from Borealis), Exceed® 1018, Enable® 2203MC (available from Exxon Mobile),
polypropylene such as BC250MO, BC545MO (available from Borealis), Adstif HA5029, Adstif HA600U, Adstif EA600P, Adstif EA648P, Clyrell RC213M, Clyrell RC5056, Hostalen PP H5416 (available from LyondellBasell Industries Holdings B.V.), Achieve® Advanced PP6936G2, Achieve® Advanced PP6945G1, Achieve® Advanced PP6035G1, ExxonMobil® PP1105E1, ExxonMobil® PP3155E5, ExxonMobil® PP9574E6 (available from Exxon Mobile),
polyolefinic copolymers of monomers such as ethene, propene, butene, hexene, preferably propylene-ethylene copolymers such as Vistamaxx 8880 (available from Exxon Mobile),
polyolefinic copolymers with non-olefinic monomers such as ethylene n-butyl acrylate copolymers such as EnBA EN 33091 (available from Exxon Mobile) or ethylene vinyl acetate copolymers such as Escorene® UltraUL 8705 (available from Exxon Mobile), ELVAX® 250 (available from Dow);
modified polyolefins such as grafted polypropylene Licocene® PP MA 1332 (available from Clariant);
poly(meth)acrylates such as polymethylmethacrylate (PMMA);
polyamides such as polyamide 12, copolyamide such as Griltex 2439 A, Griltex 1796 A, Griltex 1500 A, Griltex D 2638A (available from EMS-CHEMIE HOLDING AG); Orgasol 3502 D (available from Arkema), UNI-REZ 2620, UNI-REZ 2638, UNI-REZ 2656, UNI-REZ 2674, UNI-REZ 2720, UNI-REZ 2291 (available at Kraton Corporation); polycarbonate, poly-α-methylstyrene, polyurethanes; water-soluble or water-dispersible thermoplastic polymers such as polyalkylene glycols, polyvinyl alcohols, polyvinyl lactams, polyvinylpyrrolidons, and copolymers thereof;
polyesters such as polycaprolactone, polylactides, polyglycolides, poly(hydroxyl alkanoates) such as poly(3-hydroxy butyrate), poly(3-hydroxy valerate), poly (hydroxybutyrat-co-hydroxyvalerat) ENMAT Y1000P (available from TianAn Biologic Materials Co., Ltd.), phthalates such as polyethylene terephthalate (PET), polytrimethylene terephthalate (PTT), polybutylene terephthalate (PBT), polycarbonates, copolyesters such as Griltex 6E, Griltex 8E, Griltex 9E, Griltex D 1365E, Griltex D 1442E, Griltex D 1539E, Griltex D 1655E, Griltex D 1841E, Griltex D 1682E, Griltex D 1939E, Griltex D 2132E, Griltex D 2245E;
polyethers such as polyether ether ketone or polyoxymethylene; and mixtures thereof.

It is understood that different polymer classes can be also combined.

Generally, polyamides can be produced by a reaction of carboxylic acids and amines to amides or by reaction of moieties/derivatives of carboxylic acids and amines. Polyamide homopolymers can be produced by reaction of one monomer, i.e. amino acids or lactames having 4 to 25 carbon atoms, such as Polyamide 6 by ring opening polymerization of ε-caprolactam. Polyamides can be produced by polycondensation reaction of diamines having 4 to 25 carbon atoms and dicarboxylic acids having 4 to 25 carbon atoms or their salts, such as Polyamide 6.6 by polycondensation reaction of hexamethylenediamine and adipic acid or by reaction of hexamethylenediamine adipate. Copolyamides can be produced by polycondensation reaction of different amines with different carboxylic acids, preferably diamines having 4 to 25 carbon atoms such as hexamethylene-diamine, preferably dicarboxylic acids having 4 to 25 carbon atoms such as adipic acid, azelaic acid, dodecandioic acid, preferably amino-carboxylic acids having 4 to 25 carbon atoms such as aminoundecanoic acid, or their salts. By mixing different monomers and reaction to copolyamide ternary, quaternary and multinary system, the properties, e.g. melting point and/or viscosity and/or adhesion, of the copolyamide can be tailored. For example, by mixing the monomers of PA6 (ε-caprolactam), PA6.6 (hexamethylenediamine and adipic acid or hexamethylenediamine adipate) and PA12 (amino-laurylic acid) in a ternary system, a melting point of 110 to 120° C. can be reached in mixtures with to 40% PA6.6, 20 to 40% PA6 and 30 to 50% PA12, while the melting points of pure PA6.6, PA6 and PA12 are 250° C., 215° C. and 176° C., respectively. Reaction with branched and/or aromatic carboxylic acids and/or branched and/or aromatic amines as well as with further reaction partners such as ether, esters, elastomers and many more are known per se.

Griltex 2439 A (available from EMS-CHEMIE HOLDING AG) is particularly preferred.

Polyolefins are the group of thermoplastic polymers formed by the polymerization of olefins such as propylene, ethylene, isoprenes, and butenes which are commonly obtained from natural carbon sources such as crude oil and gas. Polyolefins contain only carbon and hydrogen atoms attached together with or without side branches. Properties of polyolefins primarily depend on the type of monomers and route of polymerization, resulting in various molar mass and degree of crystallinity. They can be simply modified by introducing various functional groups or mixed with other polymers and fillers to get tailored properties for required applications. Polyolefins such as low-density polyethylene (LDPE), linear low-density polyethylene (LLDPE), high-density polyethylene (HDPE), medium-density polyethylene (MDPE), metallocene polyethylene (mPE); cross-linked polyethylenes (xPE); cyclic polyolefins (COC); syndiotactic, isotactic and atactic polypropylene (sPP, iPP, aPP); random and homopolypropylene (rPP, hPP); thermo-elastic polyolefins (TPO), as well as other special type of polyolefins as for example polybutene (PB), polymethylpentene (P4MP), (EP), ethylene vinyl acetate (EVA), and mixtures (blends) and copolymers thereof can be used. In general, polyolefins are characterized by high chemical resistance (unaffected by alkalis and diluted acids) and low solvent solubility (unaffected by most solvents at temperatures below 60° C.).

Vistamaxx 8880, Achieve™ Advanced PP6936G2 (available from Exxon Mobile), is particularly preferred.

Water soluble or water-dispersible thermoplastic polymers such as polyalkylene glycols, or polyvinyl polymers selected from polyvinyl alcohol, polyvinyl lactams, and copolymers contain functional groups which render the polymer soluble or dispersible in common solvents such as acetone and ethanol and water. Among polyalkylene glycols, polyethylene glycols are preferred, such as polyethylene glycol 200 to polyethylene glycol 20.000 (available from Carl Roth GmbH+Co. KG). Generally, polyvinyl alcohols may be produced by saponification of polyvinyl acetate; the properties of the polyvinyl alcohol such as solubility in water are affected by the degree of saponification. Among polyvinyl lactams, polyvinyl pyrrolidone is particularly preferred. Copolymers of polyvinyl pyrrolidone and polyvinyl alcohol may also be used.

Generally, polyesters are polymers obtained by condensation reactions of difunctional reactants, e.g. diols and diacids, and are characterized by the presence of ester functions (—COO—) along the chain. Linear polyesters can be classified into three classes of aliphatic, partly aromatic and aromatic polymers. Aliphatic polyesters are obtained from aliphatic dicarboxylic acids (or esters) and aliphatic diols. Partly aromatic polyesters are obtained from aromatic dicarboxylic acids (or esters) and aliphatic diols. Aromatic polyesters have all ester functions attached to aromatic rings. By using different difunctional reactants, copolyesters can be obtained. By using at least partially multifunctional, i.e. more than difunctional, reactants, branched polyesters can be obtained.

Generally, polyethers are polymers with ether linkage in the “backbone” of the polymer chain.

It is understood that the described polymer classes also include their derivatives of thermoplastic elastomers. Thermoplastic elastomers are multiblock copolymers built up from so-called short crystallizable hard segments and long flexible segments. Owing to such chemical structure, thermoplastic elastomers exhibit an unusual combination of thermoplastic and elastomeric behavior, which might be beneficial. Thermoplastic elastomers based on polystyrene, polyolefines, polyvinyls, polyurethanes, polyester and polyamides are known per se.

The term “wax” is a collective technological term for a group of organic substances that can generally be described in terms of their physical and technical properties. In particular, waxes are characterized by the fact that they are solids with a melting point above 40° C. (usually between 50° C. and 160° C.), a low melt viscosity (below 10 Pa·s at 10° C. above the melting point). Waxes melt without decomposing. Waxes can be also divided in natural waxes of fossil origin such as paraffin, montan wax; natural waxes of natural origin such as beeswax, carnauba wax; semi-synthetic waxes (also referred to as chemically modified natural waxes) such as ethylene-bis-stearamide; synthetic waxes such as polyolefin waxes. In the context of this patent application, the expression “wax-type materials” is intended to include waxes as well as wax-type substances such as ester-type waxes, higher or polyhydric alcohols, higher fatty acids showing wax-like properties, and mixtures thereof.

Suitable wax-type materials include:
paraffin waxes such as microcrystalline wax;
ester-type waxes such as beeswax, candelilla wax, carnauba wax,
esters of organic acids such as sulfonic acids or carboxylic acids, preferably of fatty acids having 6 to 40 carbon atoms or esters of aromatic carboxylic acids such as benzoic acid, phthalic acid or hydroxybenzoic acid;
amide waxes such as amides of organic acids such as sulfonic acids or carboxylic acids, preferably of fatty acids having 6 to 40 carbon atoms such as oleamide such as Deurex A 27 P (available from DeurexAG), erucamide such as Deurex A 26 P (available from Deurex AG), ethylene-bis-stearamide such as Deurex A 20 K (available from Deurex AG); sulfonamide such as N-ethyltoluene-4-sulfonamide;
polyolefinic waxes such as
polyethylene-wax such as Deurex E 06 K, Deurex E 08, Deurex E 09 K, Deurex E 10 K (available from Deurex AG), VISCOWAX® 111, VISCOWAX® 116, VISCOWAX® 123, VISCOWAX® 135 (available from Innospec Leuna);
oxidized polyethylene wax such as Deurex EO 40 K, Deurex EO 42, Deurex EO 44 P, Deurex E 76 K (available from Deurex AG), VISCOWAX® 252, VISCOWAX® 262, VISCOWAX® 271, VISCOWAX® 2628 (available from Innospec Leuna),
copolymeric waxes of polyolefins, preferably ethylene vinyl acetate such as VISCOWAX® 334, VISCOWAX® 453 (available from Innospec Leuna), polypropylene-wax such as Deurex P 36 K, Deurex P 37 K (available from Deurex AG),
oxidized polypropylene wax;
Fischer-Tropsch wax such as VESTOWAX EH 100, VESTOWAX H 2050 MG, VESTOWAX SH 105, Shell GTL Sarawax SX 105, Shell GTL Sarawax SX 80 (available from Evonik Industries AG);
higher organic acids such as fatty acids having 10 to 40 carbon atoms;
higher or polyhydric alcohols such alcohols having 10 to 40 carbon atoms;
polyethylene glycol;
and mixtures thereof.

In an embodiment, the wax-type material is a mixture of different wax-type materials.

In an embodiment, the binder component b-li) is a plasticized thermoplastic and/or wax-type material. “Plasticized thermoplastic and/or wax-type material” means the combination of a thermoplastic and/or wax-type material with a plasticizer. Generally, a plasticizer is a high-boiling liquid with a boiling point generally above 180° C. which is compatible with the thermoplastic and/or wax-type material to decrease its melt viscosity. The skilled person will appreciate that the ternary combination of the first thermoplastic and/or wax-type material, the second thermoplastic and/or wax-type material and the plasticizer forms a homogeneous phase. Generally, plasticizers are polar compounds which means that their chemical structure comprises at least one highly electronegative heteroatom such as an oxygen atom or a nitrogen atom.

Suitably, the plasticized plasticized thermoplastic and/or wax-type material b-ii) comprises the plasticizer in an amount of up to 50 vol.-%, preferably up to vol.-%, more preferably up to 30 vol.-%, most preferably up to 20 vol.-%, in particular up to 15 vol.-%, in particular up to 10 vol.-%, relative to the total volume of b-ii).

### Suitable Plasticizers Include

liquid esters of aliphatic carboxylic acids such as dimethyl sebacate, di-n-octyl sebacate, dimethyl succinate, dimethyl adipate, dibutyl adipate, dioctyl adipate, dimethyl azelate, dioctyl azelate, di-n-butyl maleic ester, dioctyl maleate, butyl oleate, dimethyl hexanedioate, benzyl laurate, methyl laurate, ethyl myristate, diacetyl triethyl citrate, acetyl tributyl citrate;
liquid esters of aromatic carboxylic acids such as dimethyl phthalate, methyl 2-hydroxybenzoate, butyl 4-hydroxybenzoate, butyl benzoate, 2-ethylhexyl benzoate, bis(2-ethylhexyl) terephthalate;
alkylsulfonic phenyl ester;
liquid amides such as n-butylbenzenesulfonamide, N-ethyltoluene-2-sulfonamide, N-ethyl-4-toluenesulfonamide;
liquid organic acids such as carboxylic acids such as fatty acids such as caprylic acid, myristoleic acid;
higher alcohols such as 1-decanol, 2-decanol, 1-octadecanol;
polyhydric alcohols such as butanediol, ethylene glycol, propylene glycol; and mixtures thereof.

Generally, paraffin waxes such as microcrystalline wax are derived from petroleum. For example, microcrystalline wax is obtained as a refined mixture of solids mainly containing saturated aliphatic hydrocarbons produced by de-oiling of certain fractions from the petroleum refining process.

Generally, the ester-type waxes may be waxes occurring naturally or produced synthetically. Suitably, naturally occurring ester-type waxes are selected from beeswax, candelilla wax, and carnauba wax; and synthetically produced ester-type waxes are suitably selected from esters of carboxylic acids, preferably of fatty acids having 5 to 34 carbon atoms, more preferably of fatty acids having 10 to 28 carbon atoms, or esters of a hydroxybenzoic acid. Preferably, the ester-type waxes comprise the esters of a hydroxybenzoic acid such as esters of 4-hydroxybenzoic acid. Loxiol 2472 (4-hydroxybenzoic behenylester, available from Emery Oleochemicals GmbH) is particularly preferred.

Generally, polyolefin waxes can be produced by thermally decomposing branched high molecular weight polyolefins or directly polymerizing olefins. Suitable polyolefin waxes include, for example, homopolymers of propylene or higher 1-olefins, copolymers of propylene with ethylene or with higher 1-olefins or their copolymers with one another. The higher 1-olefins are preferably linear or branched olefins having 4 to 20, preferably 4 to 6 carbon atoms. These olefins may have an aromatic substitution conjugated to the olefinic double bond. Examples of these are 1-butene, 1-hexene, 1-octene or 1-octadecene, and styrene. The polyolefin waxes may be oxidized. Polyethylene waxes such as Deurex E 06 K (available from Deurex AG) are particularly preferred.

Generally, amide waxes such as amides of sulfonic acids or carboxylic acids, preferably fatty acids can be produced by condensation reactions of amides such as ethylenediamine and sulfonic acids or carboxylic acids, preferably fatty acids having 5 to 34 carbon atoms, preferably 10 to 28 carbon atoms. Oleamide such as Deurex A 27 P (available from Deurex AG), erucamide such as Deurex A 26 P (available from Deurex AG), ethylene-bis-stearamide such as Deurex A 20 K (available from Deurex AG) are particularly preferred.

According to the invention, the first thermoplastic and/or wax-type material (b-i) and the second thermoplastic and/or wax-type material (b-li) differ in at least one property which property is selected from solubility in a solvent, degradability induced by heat and/or a reactant, and volatility. In the event that the binder component ingredients (b-i) and (b-li) differ in their solubility in a solvent and the first thermoplastic and/or wax-type material (b-i) is less soluble than the second thermoplastic and/or wax-type material (b-ii), debinding is carried out as a solvent debinding step using a suitable solvent. In other words, during solvent debinding, at least a part of the second thermoplastic and/or wax-type material (b-li) is dissolved in a suitable solvent, whereas the majority of the first thermoplastic and/or wax-type material (b-i) remains within the green part. Hence, as the first thermoplastic and/or wax-type material (b-i) provides the necessary shape retention of the debound part, the first thermoplastic and/or wax-type material (b-i) is hereinafter also called “backbone polymer”.

Preferably, the first thermoplastic and/or wax-type material (b-i) is a backbone polymer selected from polyolefins, polyolefinic waxes, polyamides, poly(meth)acrylates, polyesters, polyethers, and mixtures thereof. Suitable polyolefins include polyethylenes, polypropylenes, polyolefinic copolymers with different monomers, polyolefinic copolymers with non-olefinic monomers (such as ethylene vinyl acetate or ethylene n-butyl acrylate copolymer), modified polyolefins, polyolefinic waxes, and mixtures thereof. Representatives of suitable polymer that are commercially available are those mentioned above.

In an embodiment, the backbone polymers comprise a DSC melt peak temperature T_{P} below 160° C., preferably below 150° C., more preferably below 140° C., most preferably below 130° C., in particular below 120° C., in particular below 110° C., in particular below 100° C., in particular below 90° C.

Preferably, the backbone polymers comprise a melt viscosity below 1500 Pa·s, preferably below 1300 Pa·s, more preferably below 1000 Pa·s, most preferably below 800 Pa·s, in particular below 600 Pa·s, in particular below 500 Pa·s, in particular below 400 Pa·s, in particular below 300 Pa·s, in particular below 200 Pa·s, in particular below 100 Pa·s, according to ISO 1133 with 2.16 kg at 160° C.

Preferably, the backbone polymers comprise a melt viscosity below 1500 Pa·s, preferably below 1300 Pa·s, more preferably below 1000 Pa·s, most preferably below 800 Pa·s, in particular below 600 Pa·s, in particular below 500 Pa·s, in particular below 400 Pa·s, in particular below 300 Pa·s, in particular below 200 Pa·s, in particular below 100 Pa·s, according to ISO 1133 with 2.16 kg at 190° C.

Preferably, the backbone polymers comprise a melt volume-flow rate of at least 5 cm³/10 min, preferably at least 10 cm³/10 min, more preferably at least 20 cm³/10 min, most preferably at least 30 cm³/10 min, in particular at least 40 cm³/10 min, in particular at least 50 cm³/10 min, in particular at least 60 cm³/10 min, in particular at least 70 cm³/10 min, in particular at least 80 cm³/10 min, in particular at least 90 cm³/10 min, in particular at least 100 cm³/10 min, in particular at least 110 cm³/10 min, in particular at least 120 cm³/10 min, in particular at least 130 cm³/10 min, in particular at least 140 cm³/10 min, in particular at least 150 cm³/10 min, in particular at least 160 cm³/10 min, in particular at least 170 cm³/10 min, in particular at least 180 cm³/10 min, in particular at least 190 cm³/10 min, in particular at least 200 cm³/10 min, according to ISO 1133 with 2.16 kg at 160° C.

Preferably, the backbone polymers comprise a melt volume-flow rate of at least 5 cm³/10 min, preferably at least 10 cm³/10 min, more preferably at least 20 cm³/10 min, most preferably at least 30 cm³/10 min, in particular at least 40 cm³/10 min, in particular at least 50 cm³/10 min, in particular at least 60 cm³/10 min, in particular at least 70 cm³/10 min, in particular at least 80 cm³/10 min, in particular at least 90 cm³/10 min, in particular at least 100 cm³/10 min, in particular at least 110 cm³/10 min, in particular at least 120 cm³/10 min, in particular at least 130 cm³/10 min, in particular at least 140 cm³/10 min, in particular at least 150 cm³/10 min, in particular at least 160 cm³/10 min, in particular at least 170 cm³/10 min, in particular at least 180 cm³/10 min, in particular at least 190 cm³/10 min, in particular at least 200 cm³/10 min, according to ISO 1133 with 2.16 kg and 190° C.

Preferably, b-li) is selected from polar waxes, or a plasticized thermoplastic and/or wax-type material containing a polar plasticizer.

Herein, the term “polar wax” means a wax whose chemical structure is formed essentially from, or even constituted by, carbon and hydrogen atoms, and comprising at least one highly electronegative heteroatom such as an oxygen, nitrogen or sulfur atom.

Preferably, the polar wax is selected from polyolefinic waxes, ester-type waxes, amide waxes, higher organic acids, higher or polyhydric alcohols, polyethylene glycol, and mixtures thereof.

Preferably, the ester-type waxes include esters of organic acids. Preferably, the amide waxes include amides of organic acids such as sulfonic acids or carboxylic acids. Representatives of suitable waxes that are commercially available are those mentioned above.

Preferably, the polar wax has a drop point in the range of from 20 to 160° C., more preferably in the range of from 30 to 150° C., still more preferred in the range of from 35 to 140° C., in particular in the range of from 40 to 130° C., in particular in the range of from 40 to 120° C., in particular in the range of from 40 to 110° C., in particular in the range of from 40 to 100° C., and most preferred in the range of from 40 to 90° C., according to DIN ISO 2176.

More preferably, the polar wax comprises a melt viscosity below 30 Pa·s, preferably below 20 Pa·s, more preferably below 10 Pa·s, most preferably below Pa·s, in particular below 3 Pa·s, in particular below 1 Pa·s, in particular below 700 mPa·s, in particular below 300 Pa·s, in particular below 100 mPa·s, in particular below 50 mPa·s, according to DIN EN ISO 3104 at 160° C.

More preferably, the polar wax comprises a melt viscosity below 40 Pa·s, preferably below 30 Pa·s, more preferably below 20 Pa·s, most preferably below Pa·s, in particular below 5 Pa·s, in particular below 3 Pa·s, in particular below 1 Pa·s, in particular below 700 mPa·s, in particular below 300 Pa·s, in particular below 100 mPa·s, according to DIN EN ISO 3104 at 120° C.

In a still more preferred embodiment, b-li) is a wax-type material selected from aromatic esters and aromatic sulfonamides, or a plasticized thermoplastic and/or wax-type material containing a plasticizer selected from aromatic esters and aromatic sulfonamides. The alcohol of the aromatic ester may be an alcohol having 1 to 40 carbon atoms. The aromatic sulfonamides may carry at least one organic moiety having 1 to 40 carbon atoms at the amide nitrogen atom.

Especially preferred combinations of b-i) and b-li) that have proven useful are the following:

In an embodiment, (b-i) is a polyamide, preferably a copolyamide; and (b-li) is a wax-type material selected from an ester of an organic acid and/or an amide of an organic acid, preferably aromatic esters and aromatic sulfonamides, or a plasticized thermoplastic and/or wax-type material containing a plasticizer selected from aromatic esters and aromatic sulfonamides. The polyamide preferably meets the limitations with regard to DSC melt peak temperature T_{P}, melt viscosity and melt volume-flow rate defined above for the “backbone polymer”.

In an embodiment, (b-i) is a polyester, preferably polycaprolactone, or a copolyester, preferably poly (hydroxybutyrat-co-hydroxyvalerat), and/or a polyester-based thermoplastic elastomer; and (b-li) is an ester-type wax, an ester of an organic acid, an amide wax, a higher organic acid, and/or a higher or polyhydric alcohol. The polyester or the copolyester preferably meets the limitations with regard to DSC melt peak temperature T_{P}, melt viscosity and melt volume-flow rate defined above for the “backbone polymer”.

In an embodiment, (b-i) is a polyolefin such as polyethylene; polypropylene; a polyolefinic copolymer of monomers such as ethene, propene, butene, hexane; a polyolefinic copolymer with non-olefinic monomers such as an ethylene n-butyl acrylate copolymer and/or an ethylene vinyl acetate copolymer; and/or a polyolefin wax; and/or a modified polyolefin; and (b-li) is an ester-type wax, an ester of an organic acid, an amide wax, a higher organic acid, and/or a higher or polyhydric alcohol. The polyolefin preferably meets the limitations with regard to DSC melt peak temperature T_{P}, melt viscosity and melt volume-flow rate defined above for the “backbone polymer”.

In an embodiment, the first thermoplastic and/or wax-type material (b-i) is a polyethylene wax and the second thermoplastic and/or wax-type material (b-li) is an amide wax. The combination of a polyethylene wax and an amide wax lends itself to solvent debinding using ethanol or acetone as a solvent.

In a preferred embodiment, the first thermoplastic and/or wax-type material (b-i) is a polyamide and the second thermoplastic and/or wax-type material (b-li) is a wax, preferably an ester-type wax. The combination of a polyamide and a wax lends itself to solvent debinding using acetone as a solvent.

In a preferred embodiment, the first thermoplastic and/or wax-type material (b-i) is a polypropylene wax and the second thermoplastic and/or wax-type material (b-li) is an amide wax. The combination of a polypropylene wax and an amide wax lends itself to solvent debinding using ethanol as a solvent.

In a preferred embodiment, the first thermoplastic and/or wax-type material (b-i) is a polyethylene wax and the second thermoplastic and/or wax-type material (b-i) is a water soluble or water-dispersible thermoplastic polymer such as polyethylene glycol. The combination of a polyethylene wax and a water soluble or water-dispersible thermoplastic polymer lends itself to solvent debinding using water or an aqueous solution as a solvent.

The following table illustrates combinations of (b-i), (b-ii) and solvents that have proven useful in implementing the invention; various further combinations are possible and the table shall not be limiting:

| | | |
|---|---|---|
| first thermoplastic and/or | second thermoplastic and/or | solvent |
| wax-type material (b-i) | wax-type material (b-ii) | |
| polyamide such as | ester-type waxes such as | acetone |
| copolyamide (such as | esters of a hydroxybenzoic acid | |
| Griltex 2439 A) | (such as Loxiol 2472), | |
| | optionally in combination with | |
| | stearic acid | |
| | sulfonamide such as | acetone |
| | N-ethyltoluene-4-sulfonamide | |
| | amide wax such as oleamide | |
| | (such as Deurex A27P) | |
| | optionally in combination with | |
| | stearic acid | |
| polyethylene wax (such as | amide wax such as oleamide | ethanol or |
| Deurex E06) | (such as Deurex A27P) | acetone |
| optionally with propylene- | optionally in combination with | |
| ethylene copolymer (such | | |
| as Vistamaxx 8880) | stearic acid | |
| polyethylene wax (such as | stearic acid | ethanol or |
| Deurex E06) | | acetone |
| | higher alcohols such as | ethanol or |
| | 1-octadecanol | acetone |
| | esters of organic acids such as | ethanol or |
| | monostearin (glycerol 2-stearate) | acetone |
| polypropylene wax (such | amide wax such as stearamide | ethanol |
| as Deurex P37) | (such as Deurex A28P) | |
| | optionally in combination with | |
| | stearic acid | |
| polyethylene wax (such as | polyalkylene glycol such as | water or |
| Deurex E06) | polyethylene glycol (such as | aqueous |
| | polyethylene glycol 8000) | solution |
| poly(meth)acrylate such as | ester-type waxes such as | isopropanol |
| polymethylmethacrylate | esters of a hydroxybenzoic acid | |
| (PMMA) (such as | (such as Loxiol 2472), | |
| Technovit 9100) | optionally in combination with | |
| | stearic acid | |
| | sulfonamide such as | isopropanol |
| | N-ethyltoluene-4-sulfonamide | |
| | optionally in combination with | |
| | stearic acid | |
| polyolefinic copolymer | amide wax such as oleamide | ethanol or |
| (such as Jowat 256.10) | (such as Deurex A27P) | acetone |
| | optionally in combination with | |
| | polyolefinic copolymers with | |
| | non-olefinic monomers such as | |
| | propylene-ethylene-maleic | |
| | anhydride copolymer (such as | |
| | Licocene 1332 TP) | |
| polyolefinic copolymers | ester-type waxes such as | ethanol or |
| with non-olefinic | esters of a hydroxybenzoic acid | acetone |
| monomers such as | (such as Loxiol 2472), | |
| ethylene vinyl acetate | optionally in combination with | |
| copolymer (such as Jowat | stearic acid | |
| 280.10) | optionally in combination with | |
| | polyolefinic copolymers with | |
| | non-olefinic monomers such as | |
| | propylene-ethylene-maleic | |
| | anhydride copolymer (such as | |
| | Licocene 1332 TP) | |
| | amide wax such as oleamide | ethanol or |
| | (such as Deurex A27P) | acetone |
| | optionally in combination with | |
| | polyolefinic copolymers with | |
| | non-olefinic monomers such as | |
| | propylene-ethylene-maleic | |
| | anhydride copolymer (such as | |
| | Licocene 1332 TP) | |
| | stearic acid | ethanol or |
| | | acetone |
| copolymeric wax of | amide wax such as oleamide | ethanol or |
| polyolefins such as | (such as Deurex A27P) | acetone |
| ethylene vinyl acetate | higher alcohols such as | ethanol or |
| (such as | 1-octadecanol | acetone |
| VISCOWAX 353) | esters of organic acids such as | ethanol |
| | monostearin (glycerol 2-stearate) | |
| polyolefinic copolymers | amide wax such as oleamide | ethanol or |
| with non-olefinic | (such as Deurex A27P) | acetone |
| monomers such as | optionally in combination with | |
| ethylene-n-butyl acrylate | polyolefinic copolymers with | |
| copolymer (such as | non-olefinic monomers such as | |
| EnBA EN 33901) | propylene-ethylene-maleic | |
| | anhydride copolymer (such as | |
| | Licocene 1332 TP) | |
| | esters of organic acids such as | ethanol |
| | monostearin (glycerol 2-stearate) | |
| polyester such as | ester-type waxes such as | ethanol |
| polycaprolactone | esters of a hydroxybenzoic acid | |
| | (such as Loxiol 2472), | |
| | optionally in combination with | |
| | stearic acid | |
| | esters of organic acids such as | ethanol |
| | monostearin (glycerol 2-stearate) | |
| | sulfonamide such as | ethanol |
| | N-ethyltoluene-4-sulfonamide | |
| | optionally in combination with | |
| | stearic acid | |
| | amide wax such as oleamide | ethanol |
| | (such as Deurex A27P) | |
| | optionally in combination with | |
| | polyolefinic copolymers with | |
| | non-olefinic monomers such as | |
| | propylene-ethylene-maleic | |
| | anhydride copolymer (such as | |
| | Licocene 1332 TP) | |
| | higher alcohols such as | ethanol |
| | 1-octadecanol | |
| | polyester such as diphenyl | ethanol |
| | phthalate | |
| | optionally in combination with | |
| | stearic acid | |
| polyester-based | esters of organic acids such as | ethanol or |
| thermoplastic elastomer | monostearin (glycerol 2-stearate) | acetone |
| (such as Riteflex 425) | | |

The first thermoplastic and/or wax-type material (b-i) and the second thermoplastic and/or wax-type material (b-li), respectively, may be comprised of a single material or of a mixture of materials which meet the requirements of a difference in at least one property as defined above.

The binder component (b) may comprise a dispersant. One material constituting, for example, the second thermoplastic and/or wax-type material (b-li) may act as a dispersant. Otherwise, an extraneous dispersant may additionally be incorporated.

Generally, the dispersant acts as an adhesion promotor and/or compatibilizer between the binder components (b-i) and/or (b-ii); and/or between the non-organic particles (a) and the binder component (b).

Suitably, the dispersant is selected from fatty acids having 10 to 24 carbon atoms such as capric acid, lauric acid, myristic acid, palmitic acid, stearic acid, arachidic acid, behenic acid, lignoceric acid, or oleic acid, preferably stearic acid.

Suitably, the extraneous dispersant is selected from metal salts of fatty acids. Generally, the metal may be selected from alkali metals, alkaline earth metals or transition metals such as lithium, sodium, potassium, magnesium, calcium, strontium, barium, and zinc. Suitably, the fatty acid may be selected from the fatty acids having 5 to 34 carbon atoms, preferably 10 to 28 carbon atoms as described above. Preferred metal salts of fatty acids are selected from sodium stearate, magnesium stearate, zinc stearate or magnesium oleate.

Due to the viscosity of the binder component (b) in the abovementioned ranges, the latter becomes, in the molten state, uniformly and homogeneously distributed between the sinterable non-organic particles (a) and joins the individual sinterable non-organic particles (a) or the individual particulate feedstock compounds.

In order to adjust the viscosity of the binder component (b), it may be desirable to incorporate a thinning agent or thickening agent. The thickening agent serves to increase the viscosity of the binder component when molten. This enhanced viscosity prevents the sag of the sinterable non-organic particles and facilitates uniform flow of the particles and imparts resistance to segregation and sedimentation.

The viscosity of the binder component (b), in particular, is adjusted, i.e. reduced or increased, by means of the thickening or thinning agent. Thinning agents are employed to lower the viscosity of the overall binder component. Thickening agents are employed to increase the viscosity of the overall binder component. The thinning agent can act as a plasticizer to allow control of the rheological properties and the fluidity of the first thermoplastic and/or wax-type material (b-i) or the second thermoplastic and/or wax-type material (b-li).

Suitably, the thickening or thinning agent is selected from waxes and/or thermoplastic polymers such as polyolefins and polyolefin waxes, polyamides and amide waxes, paraffin waxes, ester-type waxes; vinyl esters such as ethylene vinyl acetate; abietates; adipates; alkyl sulfonates; amines and amides such as formamide, hydroxylalkylformamide, amine, diamine; azelates; benzoates; citrates; chlorinated paraffins; ether-ester plasticizers; glutarates; hydrocarbon oils; isobutyrates; maleates; oleates; phosphates; phthalates; sulfonamides; oily liquids such as peanut oil, fish oil, castor oil; and mixtures thereof. Suitably, polyethylene wax Deurex E 09 K having a viscosity of <40 mPa·s at 140° C. can be used as a thinning agent, while Deurex E 25 having a viscosity of 4000 mPa·s at 140° C. or even higher molecular weight polyolefinic compounds can be used as thickening agent.

In an embodiment, the thickening or thinning agent and/or dispersant may be present in an amount of 0 to 15% by volume, preferably 0.01 to 10% by volume, more preferably 0.02 to 8% by volume, most preferably 0.5 to 6% by volume, based on the total volume of the binder component (b).

In an embodiment, the binder component (b) exhibits a viscosity, as determined at a temperature of 130° C.; and at a shear rate of 1 s⁻¹, of below 6 Pa·s, preferably below 5 Pa·s, more preferably below 4 Pa·s, most preferably below 3 Pa·s, in particular below 2 Pa·s, in particular below 1 Pa·s, in particular below 700 mPa·s, in particular below 400 mPa·s, in particular below 200 mPa·s. The determination of the viscosity is carried out in accordance with EN ISO 3219:1994.

In an embodiment, the binder component (b) exhibits a viscosity, as determined at a temperature of 110° C.; and at a shear rate of 1 s⁻¹, of below 10 Pa·s, preferably below 8 Pa·s, preferably below 6 Pa·s, more preferably below 5 Pa·s, most preferably below 4 Pa·s, in particular below 3 Pa·s, in particular below 2 Pa·s, in particular below 1 Pa·s, in particular below 600 mPa·s, in particular below 300 mPa·s. The determination of the viscosity is carried out in accordance with EN ISO 3219:1994.

In an embodiment, the binder component (b) exhibits a viscosity, as determined at a temperature of 100° C.; and at a shear rate of 1 s⁻¹, of below 10 Pa·s, preferably below 8 Pa·s, more preferably below 6 Pa·s, most preferably below Pa·s, in particular below 4 Pa·s, in particular below 3 Pa·s, in particular below 2 Pa·s, in particular below 1 Pa·s, in particular below 500 mPa·s. The determination of the viscosity is carried out in accordance with EN ISO 3219:1994.

### Particulate Feedstock Compound

Herein, the term “particulate” denotes that the feedstock compound is composed of particles of arbitrary shape such as irregular, cylindrical, rotational ellipsoid or essentially spherical, or filaments.

The particulate feedstock compound of the invention contains sinterable non-organic particles (a) and the binder component (b) as described above and is useful in a shaping and sintering process.

Thus, the invention further relates to a particulate feedstock compound for use in a shaping and sintering process, containing
a) sinterable non-organic particles dispersed throughout the particulate feedstock compound, the sinterable non-organic particles having a particle size distribution such that at least 80% of the particles have a maximum particle size Aₘₐₓ in the range of 100 nm to 400 μm; and
b) the binder component as described above.

The sinterable non-organic particles (a) include conventionally known sinterable materials. In general, the sinterable non-organic particles (a) are selected from metals, alloys, vitreous particles and ceramic particles.

In an embodiment, metals are selected from iron, stainless steel, steel, copper, bronze, aluminum, tungsten, molybdenum, silver, gold, platinum, titanium, nickel, cobalt, chromium, zinc, niobium, tantalum, yttrium, silicon, magnesium, calcium and combinations thereof. Suitably, the metal particles have a particle size distribution such that at least 85%, preferably at least 90%, more preferably at least 95%, most preferably at least 99% of the particles have a maximum particle size Aₘₐₓ in the range of 500 nm to 400 μm, preferably 1 μm to 150 μm, more preferably 3 μm to 50 μm, most preferably 5 μm to 25 μm.

Suitably, alloys are selected from steels such as stainless steels (316 L, 17-4 PH), chromium-nickel steels, bronzes, copper alloys such as Hovadur, nickel-base alloys such as Hastelloy or Inconel, cobalt and cobalt-chromium alloys such as stellite, aluminum alloys such as Aluminum 6061, tungsten heavy alloys, titanium alloys such as grade 1 via grade 5 (Ti-6Al-4V) to grade 38 according to ASTM.

In an embodiment, ceramic particles are selected from oxides such as aluminum oxides, silicon oxides, zirconium oxides, titanium oxides, magnesium oxides, yttrium oxides; carbides such as silicon carbides, tungsten carbides; nitrides such as boron nitrides, silicon nitrides, aluminum nitrides; silicates such as steatite, cordierite, mullite; and combinations thereof. Suitably, the ceramic particles have a particle size distribution such that at least 85%, preferably at least 90%, more preferably at least 95%, most preferably at least 99% of the particles have a maximum particle size Aₘₐₓ in the range of 200 nm to 25 μm, preferably 300 nm to 10 μm, more preferably 400 nm to 7 μm, most preferably 500 nm to 3 μm.

In an embodiment, vitreous particles are selected from non-oxide glasses such as halogenide glasses, chalcogenide glasses; oxide glasses such as phosphate glasses, borate glasses, silicate glasses such as aluminosilicate glasses, lead silicate glasses, boron silicate glasses, soda lime silicate glasses, quartz glasses, alkaline silicate glasses; and combinations thereof. Suitably, the vitreous particles have a particle size distribution such that at least 85%, preferably at least 90%, more preferably at least 95%, most preferably at least 99% of the particles have a maximum particle size Aₘₐₓ in the range of 200 nm to 25 μm, preferably 300 nm to 10 μm, more preferably 400 nm to 7 μm, most preferably 500 nm to 3 μm.

Suitably, the sinterable non-organic particles (a) may contain combinations of more than one of metals, alloys, vitreous particles and ceramic particles as described above, for example hard metals or metal matrix composites (also referred to as metal ceramic composites).

In an embodiment, the particulate feedstock compound contains the sinterable non-organic particles (a) in an amount of about 0.70 to 0.99·ϕᵣ by volume, preferably about 0.75 to 0.98·ϕᵣ by volume, more preferably about 0.80 to 0.96·ϕᵣ by volume, most preferably about 0.82 to 0.95·ϕᵣ by volume, in particular about 0.84 to 0.94·ϕᵣ by volume, in particular about 0.86 to 0.93·ϕᵣ by volume, wherein ϕᵣ is the critical solids loading by volume. The remainder is comprised of binder component b).

Generally, the term “critical solids loading” is referred to as the amount of sinterable non-organic particles by volume in a feedstock compound at a critical limit. Said “critical limit” is reached when the feedstock compound becomes stiff and does not flow due to the relative viscosity becoming infinite upon addition of sinterable non-organic particles to the feedstock compound. Physically, “critical solids loading” defines the maximum packing arrangement of particles while still retaining a continuous material and it is the limit above which it is not possible to continue loading the binder matrix with solid powders. In this context, the term “relative viscosity” denotes the viscosity of the feedstock compound in relation to the viscosity of the neat binder in order to isolate the effect of the sinterable non-organic particles. The viscosity of the feedstock compound increases upon addition of sinterable non-organic particles.

There are several ways to determine the critical solids loading. For example, one can determine the peak in the torque of a kneader when more and more metal powder is added to the binder. After critical solids loading is reached, the torque usually decreases again as the feedstock compound becomes more friable. Alternatively, a pycnometer measurement may be used: up to the critical solids loading, the theoretical density is in agreement with the measured density at the pycnometer, above the critical solids loading, the measured density is below the theoretical density due to pores (see also: 1990, R. M. German, Powder Injection Molding, Metal Powder Industries Federation 1990, p.129-130). Rheological measurements may also be used to estimate the value of the critical solids loading by plotting ϕ·ηᵣ: (ηᵣ−1) versus ϕ(J. S. Chong, E. B. Christiansen, A. D. Baer, J. Appl. Polym. Sci. 1971, 15, 2007-2021). In this context, ϕdenotes the loading, ηᵣ denotes the relative viscosity.

Alternatively, in an embodiment, the particulate feedstock compound contains the sinterable non-organic particles (a) in an amount of about 20 to 90% by volume, preferably 30 to 80% by volume, more preferably 40 to 75% by volume, most preferably 45 to 70% by volume, in particular 50 to 65% by volume, and the binder component (b) in an amount of about 10 to 80% by volume, preferably to 70% by volume, more preferably 25 to 60% by volume, most preferably 30 to 55% by volume, in particular 35 to 50% by volume.

The binder component (b) comprises at least two binder component ingredients: the first thermoplastic and/or wax-type material (b-i) and the second thermoplastic and/or wax-type material (b-li). Optionally, the binder component (b) may comprise further functional additives in view of good processability.

Each particulate feedstock compound comprises a plurality of sinterable non-organic particles (a) dispersed throughout the particulate feedstock compound within a matrix of the binder component (b) and is held together by the binder component (b). A plurality of sinterable non-organic particles (a) per particulate feedstock compound makes it possible for the shape of the particulate feedstock compound to be independent of the shape of the sinterable non-organic particles (a). Thus, for example, substantially spherical particulate feedstock compounds can be produced without the necessity of the sinterable non-organic particles (a) being spherical. This reduces the production costs since sinterable non-organic particles (a) with arbitrary or irregular particle geometry or broader particle size distribution are more readily available than powders having a particular, e.g., spherical, particle geometry.

In an embodiment, the particulate feedstock compound exhibits a viscosity, as determined at a temperature of 130° C., and a shear rate of 1 s⁻¹, of below 600 Pa·s, preferably below 400 Pa·s, more preferably below 350 Pa·s, most preferably below 250 Pa·s, in particular below 150 Pa·s, in particular below 50 Pa·s, in particular below 10 Pa·s. The determination of the viscosity is carried out in accordance with EN ISO 3219:1994.

In an embodiment, the particulate feedstock compound exhibits a viscosity, as determined at a temperature of 110° C., and a shear rate of 1 s⁻¹, of below 800 Pa·s, preferably below 550 Pa·s, more preferably below 450 Pa·s, most preferably below 350 Pa·s, in particular below 200 Pa·s, in particular below 100 Pa·s, in particular below 60 Pa·s. The determination of the viscosity is carried out in accordance with EN ISO 3219:1994.

In an embodiment, the particulate feedstock compound exhibits a viscosity, as determined at a temperature of 100° C., and a shear rate of 1 s⁻¹, of below 1000 Pa·s, preferably below 850 Pa·s, more preferably below 700 Pa·s, most preferably below 550 Pa·s, in particular below 400 Pa·s, in particular below 250 Pa·s, in particular below 100 Pa·s. The determination of the viscosity is carried out in accordance with EN ISO 3219:1994.

The particulate feedstock compounds are, for example, produced by subjecting a suspension of sinterable non-organic particles (a) and a solvent, e.g. an alcoholic solvent, in which the binder component (b) was dissolved, to spray drying. Alternatively, a solidified melt of the binder component (b) having dispersed therein the sinterable non-organic particles (a) may be milled. Larger particulate feedstock compounds may also be compounded by an extruder with subsequent granulation.

Generally, for use in 3D printing and pressing, the particulate feedstock compounds have a particle size distribution such that at least 80% by volume, preferably at least 90% by volume, more preferably at least 95% by volume, most preferably at least 99% by volume, of the particulate feedstock compounds have a maximum particle size Bₘₐₓ in the range of 0.005 to 0.3 mm, preferably 0.008 to 0.2 mm, more preferably 0.01 to 0.2 mm, most preferably 0.015 to 0.15 mm.

For use in injection molding processes, the particulate feedstock compounds have a maximum particle size Bₘₐₓ in the range of 1 to 10 mm, preferably 2 to 8 mm, more preferably 3 to 5 mm.

### Process

The invention further relates to a process comprising the steps of:
merging a plurality of the particulate feedstock compounds to obtain a green part, and
partially debinding the green part by selectively removing the second thermoplastic and/or wax-type material (b-li) to obtain a brown part comprising the sinterable non-organic powder particles (a) bound to each other by the first thermoplastic and/or wax-type material (b-i).

In an embodiment, the process is selected from an additive manufacturing process such as a laser additive manufacturing process or an extrusion additive manufacturing process; an injection molding process such as a medium pressure injection molding process or a low pressure injection molding process; a pressing process, and a casting process, preferably an additive manufacturing process such as a laser additive manufacturing process or an extrusion additive manufacturing process.

In the context of the present patent application, the term “merging” refers to “selectively melting and solidifying” in the event that the process is selected from an additive manufacturing process using radiation; or the term “merging” refers to “melting and solidifying” in the event that the process is selected from an injection molding process or a casting process or a filament printing process or a pellet printing process; or the term “merging” refers to “compacting” or “compacting, partly or fully melting and solidifying” in the event that the process is selected from a pressing process.

By carefully selecting the components and process parameters, components may be obtained which preferably do not have any cracking. Such cracking occurs, e.g., when debinding is carried out too fast or at harsh conditions. Thus, the components and process parameters are preferably selected such that harmful conditions are avoided.

Generally, in an additive manufacturing process using radiation from a laser-array, radiation heating element etc., e.g. a laser additive manufacturing process or a multi jet fusion process from HP Inc., the particulate feedstock compounds are applied layer-wise followed by densification and solidifying, e.g. by cooling. During the densification, the binder component (b) which is comprised in the particulate feedstock compounds is selectively and layer-wise molten by means of electromagnetic radiation, e.g. of a laser.

In a preferred embodiment, the step of merging a plurality of the particulate feedstock compounds comprises the steps of:
providing a first layer of feedstock compound particles;
selectively densifying the first layer of feedstock compound particles to bind the compound particles to each other in a predefined manner so to produce a first shaped part layer;
providing at least one further layer of feedstock compound particles on the first shaped part layer; and
selectively densifying the further layer feedstock compound particles to bind the feedstock compound particles to each other in a predefined manner so to produce at least one further shaped part layer, the first shaped part layer and the further shaped part layers forming a green part.

Generally, an extrusion additive manufacturing process is a process in which a feedstock compound is fed as filament or granule, is melted in a heated printer extruder head, and is deposited layer-wise to build up a green part. The print head is moved under computer control to define the printed shape. Usually, the head moves in two dimensions to deposit one horizontal plane, or layer, at a time; the work or the print head is then moved vertically by a small amount to begin a new layer. After the printing process, the shaped feedstock compound can be removed as a solidified green part. The green part comprises the sinterable non-organic powder particles and the binder.

Generally, an injection molding process such as a medium pressure injection molding process or a low pressure injection molding process, is a process in which a finely-powdered feedstock material is mixed with a binder to create a feedstock compound which is then molten and injected into a mold in a liquid state (shaping). After cooling, the shaped feedstock compound solidifies inside the mold and can be taken out giving a green part (molding). The green part comprises the feedstock and the binder. In the case of the finely-powdered material being a metal or an alloy, the process is referred to as metal injection molding (MIM) process. In the case of the finely-powdered material being a ceramic, the process is referred to as a ceramic injection molding (CIM) process. In general, processes including finely-powdered material are referred to as powder injection molding (PIM) processes. Further suitable sinterable non-organic powder particles include, for example, glasses, ceramics, or polymers, or mixtures thereof.

Generally, a casting process is a process in which the feedstock compound is molten and poured into a casting mold in a liquid state (shaping). After cooling, the shaped feedstock compound solidifies inside the casting mold and can be taken out giving a green part. The green part comprises the feedstock and the binder. In an embodiment, the casting mold is a lost casting mold, i.e. the casting mold can be only used for one green part, since the casting mold e.g. has to be broken for obtaining the green part. The lost casting mold can be manufactured by different methods such as casting or additive manufacturing, e.g. by an extrusion additive manufacturing process or an inkjet additive manufacturing process. The lost form could be printed of a polymer, that is also soluble in a solvent, such as acrylonitrile-butadiene-styrene (ABS) in acetone. In an embodiment, one section of the casting form is printed, that section is at least partly filled with the feedstock compound, these steps are repeated until the printing of the casting form and filling of the casting form is finished. Preferably both, cast and green part, can be dissolved and debound in the same solvent. The green part comprises the sinterable non-organic powder particles and the binder. After the shaping by casting step, the green part undergoes conditioning operations to densify the powders (sintering).

Generally, in a pressing process, a green part may be formed from particulate feedstock compounds comprising finely-powdered feedstock and a binder by applying high pressures on a plurality of particulate feedstock compounds for densification (shaping by pressing). Suitably, the densification may be accompanied by heat, the particulate feedstock compound may be partially or fully melted. The green part comprises the sinterable non-organic powder particles and the binder. After the shaping by pressing step, the green part undergoes conditioning operations to densify the powders (sintering).

The aforementioned processes may also be combined. In the following, preferred combination of processes are described in detail. These processes may be carried out using the particulate feedstock compounds as described above. Alternatively, any other particulate feedstock compound comprising an organic binder component and sinterable non-organic particles can be employed, in particular those wherein the binder component comprises a first thermoplastic and/or wax-type material and a second thermoplastic and/or wax-type material, wherein the first thermoplastic and/or wax-type material and the second thermoplastic and/or wax-type material differ in at least one property as described above.

In an embodiment, a green part is casted or molded before printing via extrusion based processes on the green part.

In an embodiment, the green parts produced via different processes, e.g. one part is 3D-printed and another part is molded, are taken and joined as green parts or brown parts. Suitable processes for joining are selected from welding and bonding processes. For bonding, suitable adhesives are selected from slurries containing a polymeric binder such as polyvinylalcohols, galantines or agar and a solvent such as water or alcohol and suitable non-organic particles, preferably sinterable non-organic particles, more preferably sinterable non-organic particles with the same composition as the sinterable non-organic particles in the green part or brown part.

In an embodiment, the process comprises the steps of:
providing a first green part by an additive manufacturing process,
placing the first green part in a mold,
melting a portion of particulate feedstock compound according to the invention and casting or injection molding of the molten portion into the mold, wherein the molten portion forms an interface with the first green part,
solidifying the portion so that the first green part becomes an integral part of the cast green part, and
partially debinding the cast green part to obtain a brown part.

Preferably, the first green part is manufactured in a 3D-printing process that leads to uniform shrinkage and no distortion of the first green part in the sintering step. Thus, the first green part is preferably produced by selectively melting and solidifying a plurality of particulate feedstock compound according to the invention by additive manufacturing to obtain the first green part.

In other words, a first green part is manufactured by 3D-printing, the 3D-printed first green part is subsequently placed in a mold and overmold and/or overcast.

Such combination of processes is advantageous in terms of process efficiency if only one or more key portions of the part to be manufactured have a complex design and/or require high geometric accuracy, whereas the remaining portions of the part, e.g. the periphery around the key portion, require a less accurate geometry. Also, the combination of different materials such as in two component metal injection molding processes is possible. In other words, a first green part is manufactured in one material and the 3D-printed first green part is subsequently placed in a mold and overmold and/or overcast with another suitable material.

In this case, the first green part is produced from the first portion of feedstock compound via a 3D-printing process, and placed in a mold. Afterwards, the second portion of the feedstock compound is molten and cast or injected into the mold.

The inventive feedstock compound is especially eligible for carrying out such combination of processes. This is due to the high dimensional stability of the first green part and a high compatibility of the molten second portion of the feedstock compound, i.e. the high ability of the molten second portion to adhere to the first green part.

The mold is configured to receive the molten second portion of the feedstock compound in a way that the molten second portion forms an interface with the first green part. In other words, the molten second portion contacts the first green part for joining to obtain, after solidification, the integral part of the cast green part. For example, the molten second portion is deposited in a location adjacent to the first green part or is deposited adjacent to and on top of the first green part.

Preferably, the mold and/or the first green part is pre-heated to a temperature of at least 40° C., preferably at least 50° C., more preferably at least 60° C., most preferably close below to the DSC melt peak temperature T_{P}. This is to promote the better joining of the first green part and the cast second portion of the feedstock compound.

In an embodiment, the process comprises the steps of:
providing a first green part;
placing the first green part in a build chamber;
providing a first layer of feedstock compound particles on the first green part;
selectively densifying the first layer of feedstock compound particles to bind the compound particles to each other in a predefined manner so to produce a first shaped part layer joined to the first green part;
optionally, providing at least one further layer of feedstock compound particles on the first shaped part layer; and
selectively densifying the further layer feedstock compound particles to bind the feedstock compound particles to each other in a predefined manner so to produce at least one further shaped part layer joined to the first shaped part layer, the first shaped part layer and the further shaped part layers together with the first green part jointly forming an integral part
partially debinding the integral part to obtain a brown part.

In this case, the first green part is produced from the first portion of feedstock compound via a molding or casting or additive manufacturing process and placed in a build chamber. Afterwards, the second portion of the feedstock compound is applied and a portion of particulate feedstock compound is melted using radiation from a laser-array, radiation heating element etc., e.g. a laser additive manufacturing process or a multi jet fusion process from HP Inc., the particulate feedstock compounds are applied layer-wise followed by densification and solidifying, e.g. by cooling. During densification, the binder component (b) which is comprised in the particulate feedstock compounds is selectively and layer-wise molten by means of electromagnetic radiation, e.g. of a laser.

Such combination of processes is advantageous in terms of process efficiency if only one or more key portions of the part to be manufactured have a complex design and/or require high geometric accuracy, whereas the remaining portions of the part, e.g. the periphery around the key portion, require a less accurate geometry. Also, the combination of different materials such as in two component metal injection molding is possible. In other words, a first green part is manufactured in one material and the applied particulate feedstock compound is another suitable material.

The inventive feedstock compound is especially eligible for carrying out such combination of processes. This is due to the high dimensional stability of the first green part and a high compatibility of the molten second portion of the feedstock compound, i.e. the high ability of the molten second portion to adhere to the first green part.

The building chamber is configured to receive the particulate feedstock compound in a way that it covers the first green part. Upon selectively densifying, for example by a laser additive manufacturing process, the feedstock compound particles are bound to each other in a predefined manner so to produce a first shaped part layer joined to the first green part via a common interface. Then, at least one further layer of feedstock compound particles is selectively densified on the first shaped part layer to bind the feedstock compound particles to each other in a predefined manner so to produce at least one further shaped part layer joined to the first shaped part layer. The first shaped part layer and the further shaped part layers together with the first green part jointly form an integral part. The integral part may then be removed from the building chamber and freed from unbound particulate feedstock compound.

Preferably, the first green part is pre-heated to a temperature of at least 40° C., preferably at least 50° C., more preferably at least 60° C., most preferably at least close to the DSC melt peak temperature T_{P}. This is to promote the better joining of the first green part and the second portion of the feedstock compound.

In each process, the binder component (b) becomes distributed between the sinterable non-organic particles (a) and holds them together after solidification. After the green part was made, it is taken out from the unmelted layers or the mold.

According to an embodiment, the partial removal of the temporary organic binder can be effected by one or more of the following steps:
the first thermoplastic and/or wax-type material (b-i) has a lower solvent solubility than the second thermoplastic and/or wax-type material (b-li) and partial debinding is carried out by solvent treatment in a solvent treatment process;
the first thermoplastic and/or wax-type material (b-i) has a different thermal degradability and/or different reactant degradability than the second thermoplastic and/or wax-type material (b-li) and partial debinding is carried out by thermal treatment in a thermal treatment process and/or chemical treatment in a chemical treatment process;
the first thermoplastic and/or wax-type material (b-i) has a different vapor pressure at a specific temperature than the second thermoplastic and/or wax-type material (b-li) and partial debinding is carried out by thermal treatment in a thermal treatment process.

Among the steps for partial removal of the binder, the solvent treatment process is preferred.

The use of a first thermoplastic and/or wax-type material (b-i) with different solvent solubility and/or different thermal degradability and/or different reactant degradability and/or different volatility compared to the second thermoplastic and/or wax-type material (b-li) allows for selective removal of one or more binder components during the debinding step. Suitably, the second thermoplastic and/or wax-type material (b-li) is selectively removed, whereas the first thermoplastic and/or wax-type material (b-i) is not removed. The resulting part after the debinding step is referred to as a brown part. The brown part comprises sinterable non-organic particles (a) bound to each other by the first thermoplastic and/or wax-type material (b-i) and, optionally, remaining second thermoplastic and/or wax-type material (b-li).

The remaining binder components retained in the brown part provide a brown part that is stable and sufficiently strong to be handled and transported between the debinding and sintering steps.

In the solvent treatment process, the green part is dipped into a suitable solvent. Suitably, the solvent is selected such that the first thermoplastic and/or wax-type material (b-i) has a lower solubility than the second thermoplastic and/or wax-type material (b-li) in the solvent or, preferably, the first thermoplastic and/or wax-type material (b-i) is essentially insoluble in the solvent and the second thermoplastic and/or wax-type material (b-li) is soluble in the solvent. Suitable solvents are selected from alcohols such as ethanol or propanol; aromatic compounds such as benzene, toluene or xylenes; esters such as ethyl acetate; ethers such as diethylether or tetrahydrofuran; ketones such as acetone; alkanes such as hexane or heptane; halogenated hydrocarbons such as n-propyl bromide, trichloroethylene, perchloroethylene, n-methyl pyrrolidine; water; gases in supercritical state; and mixtures thereof. During the solvent treatment process, the solvent is preferably kept at a temperature TL in the range of 20 to 100° C., preferably 25 to 80° C., more preferably 30 to 60° C.

In the chemical treatment process, the green part to be debound is treated in a reactive gas atmosphere. Suitably, the green part is placed in a reactive gas atmosphere so that the reactive gas can infiltrate the pores of the green part comprising the binder components. The binder components (b-li) are degraded (decomposed) by reaction with the reactive gas giving a debound green part (brown part) after removal of the binder components (b-li). Such reactive gas atmosphere may comprise a gas, preferably nitric acid. Suitably, the chemical treatment process is carried out at elevated temperature levels. For example, the temperature in the chemical treatment process may be in the range of 40 to 150° C., preferably 60 to 140° C., more preferably 80 to 130° C.

The partial removal of the binder component (b-li) results in a porous structure of the brown part. The sinterable non-organic particles (a) are held together by the first thermoplastic and/or wax-type material (b-i).

### Sintering Step

In an embodiment, the process further comprises the step of sintering the brown part to obtain a sintered part.

For this purpose, the brown part is suitably subjected to a sintering step after the debinding step. During the sintering step, the first thermoplastic and/or wax-type material (b-i) is removed and the debound part (brown part) is sintered to obtain the sintered part. Generally, on further removal of the binder and the subsequent sintering of the brown part, shrinkage occurs.

Suitably, the residual binder is driven out at a first temperature T₁ which is in the range of 100 to 750° C., preferably 150 to 700° C., more preferably 200 to 650° C., most preferably 300 to 600° C. A suitable temperature T₁ may also be dependent on the atmosphere. Preferably, the first temperature T₁ is selected as a function of the residual binder components, e.g., the first thermoplastic and/or wax-type material (b-i). The removal of the first thermoplastic and/or wax-type material (b-i) at the temperature T₁ is carried out for a period of time Δt₁ which is dependent on the part geometry and in particular is proportional to the square of the wall thickness of the part to be produced. Preferably, the period of time Δt₁ is selected such that at least 95%, preferably at least 99%, more preferably at least 99.9%, most preferably 100% of the binder components (b-i) and (b-li) are removed. Binder which is not removed is not available as polymeric binder in the part but is diffused, e.g. as carbon, into the metal part and increases the carbon content in the metal part. Thermal debinding may be carried out at more than one temperature Ti, e.g. the removal of a part of the first thermoplastic and/or wax-type material (b-i) at the temperature T₁ₐ is carried out for a period of time Δt₁ₐ and the removal of the rest of the first thermoplastic and/or wax-type material (b-i) at the temperature T_{1b} is carried out for a period of time Δt_{1b}.

The sinterable non-organic particles (a) partly form sintering necks, so that the part is held together despite removal of the remaining binder components. Owing to the microporous structure of the part, thermal binder removal occurs quickly and uniformly.

Undesirable chemical reactions during the thermal binder removal may be avoided by means of an inert gas atmosphere or a reducing atmosphere or high vacuum. The inert gas atmosphere comprises, in particular, at least one noble gas which noble gas may suitably be selected from, e.g., nitrogen, helium and argon. The reducing atmosphere may include gases such as hydrogen, carbon dioxide, and/or carbon monoxide.

Suitably, sintering is carried out at a second temperature T₂ which is in the range of 600 to 2000° C., preferably 800 to 1800° C., more preferably 900 to 1500° C. In the production of a ceramic and/or vitreous part, the second temperature T₂ is preferably in the range of 600 to 2400° C., more preferably 800 to 2200° C., most preferably 1100 to 2000° C. In any case, the sintering temperature T₂ is below the melting temperature of the sinterable non-organic particles. The sintering at the second temperature T₂ is carried out for a period of time Δt₂ which is dependent on the geometry of the part and the material to be sintered. Preferably, the period of time Δt₂ is so long that no significant change in the porosity of the part can be achieved by subsequent further sintering. Sintering may be carried out at more than one temperature T₂, e.g. a sintering step at the temperature T₂ₐ is carried out for a period of time Δt₂ₐ and another sintering step at the temperature T_{2b} is carried out for a period of time Δt_{2b}.

During this sintering step, the molded part will shrink essentially without affecting the shape of the molded part. The powder particles will fuse together and the open space between the powder particles disappears. Hence, during sintering, the density of the product increases and the product shrinks. The sintering step is commonly completed when the product has reached a density of about 90 to 100% by volume of the solid of which the powder is made, depending on the material and later use of the product.

Preferably, after the sintering step, the part is completely free of binder. As a result, the part forms an integral structure of high density.

The present invention is described in detail below with reference to the attached figures and examples.

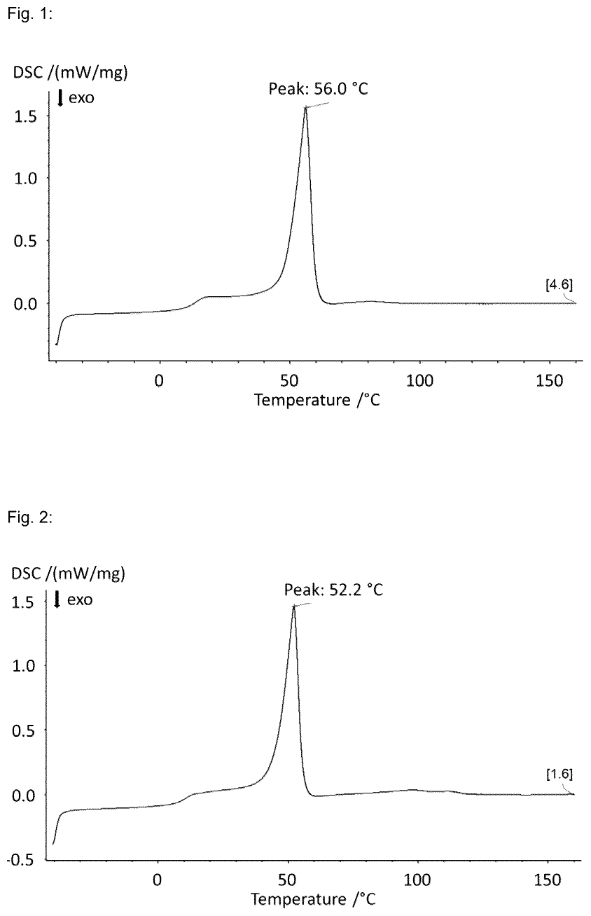

FIG. 1 depicts the second heat ramp of a DSC measurement of binder component 1-B for determining the melt peak temperature T_{P} of 1-B.

FIG. 2 depicts the second heat ramp of a DSC measurement of binder component 3-B for determining the melt peak temperature T_{P} of 3-B.

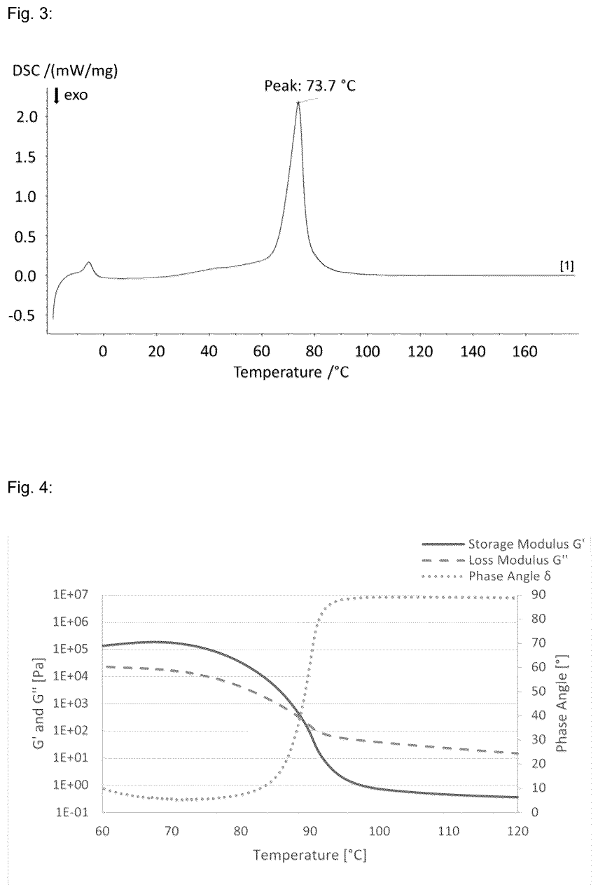

FIG. 3 depicts the second heat ramp of a DSC measurement of binder component 4-B for determining the melt peak temperature T_{P} of 4-B.

FIG. 4 depicts the storage modulus G′ curve and the loss modulus G″ curve of a dynamic viscoelasticity measurement during heating of binder component 1-B for determining the cross-over temperature T_{cross} of 1-B.

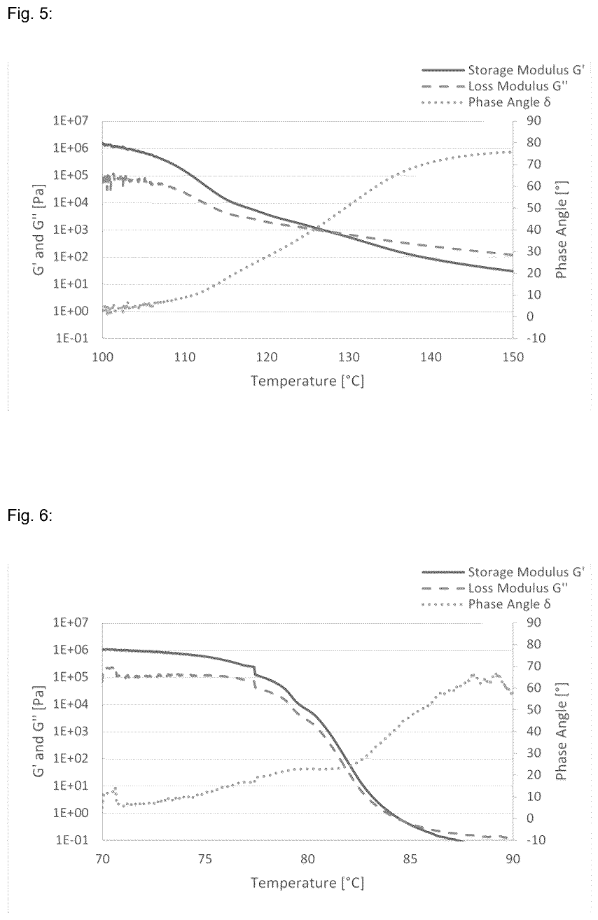

FIG. 5 depicts the storage modulus G′ curve and the loss modulus G″ curve of a dynamic viscoelasticity measurement during heating of binder component 3-B for determining the cross-over temperature T_{cross} of 3-B.

FIG. 6 depicts the storage modulus G′ curve and the loss modulus G″ curve of a dynamic viscoelasticity measurement of binder component 4-B for determining the cross-over temperature T_{cross} of 4-B. FIG. 6 was recorded during cooling since a higher value of T_{cross} was recorded during cooling.

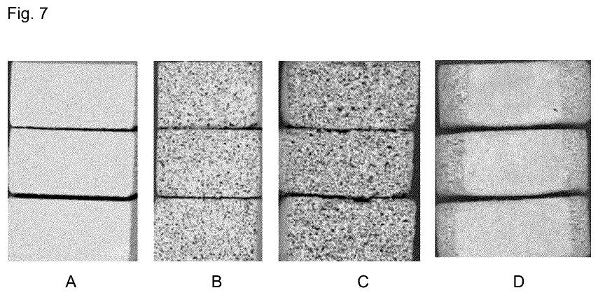

FIG. 7 depicts the cylindrical testing specimen (green parts) obtained from feedstock compounds according to table 2, 1-F (FIG. 7 A), 2-F (FIG. 7 B), 3-F (FIG. 7 C) and 4-F (FIG. 7 D).

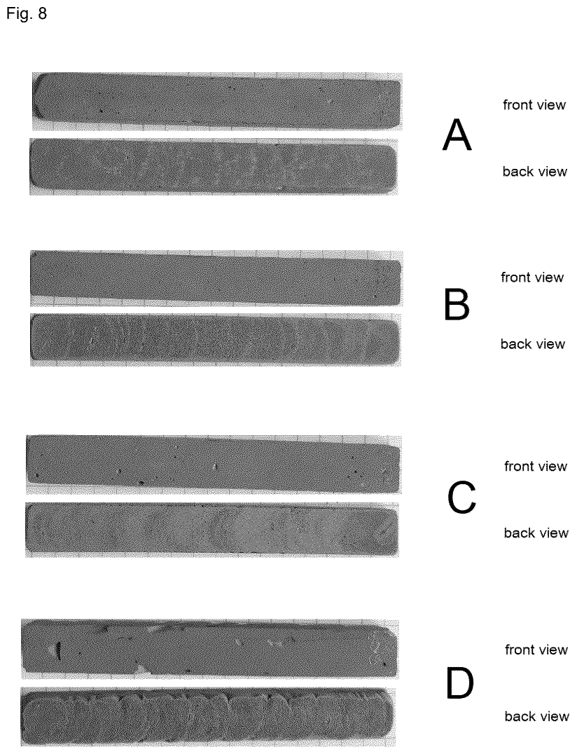

FIG. 8 depicts the testing specimen (green parts) in front view and back view which were obtained by a molding process using feedstock compounds 1-F (FIG. 8 A), 2-F (FIG. 8 B), 3-F (FIG. 8 C) and 5-F (FIG. 8 D).

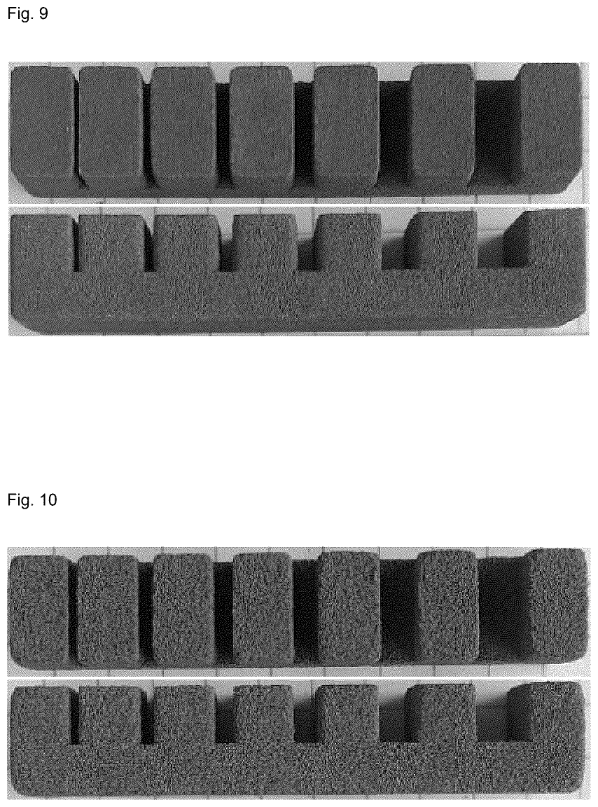

FIG. 9 depicts the notched specimen in side view and top view obtained from the feedstock compound according to table 2, 1-F.

FIG. 10 depicts the notched specimen in side view and top view obtained from the feedstock compound according to table 2, 2-F.

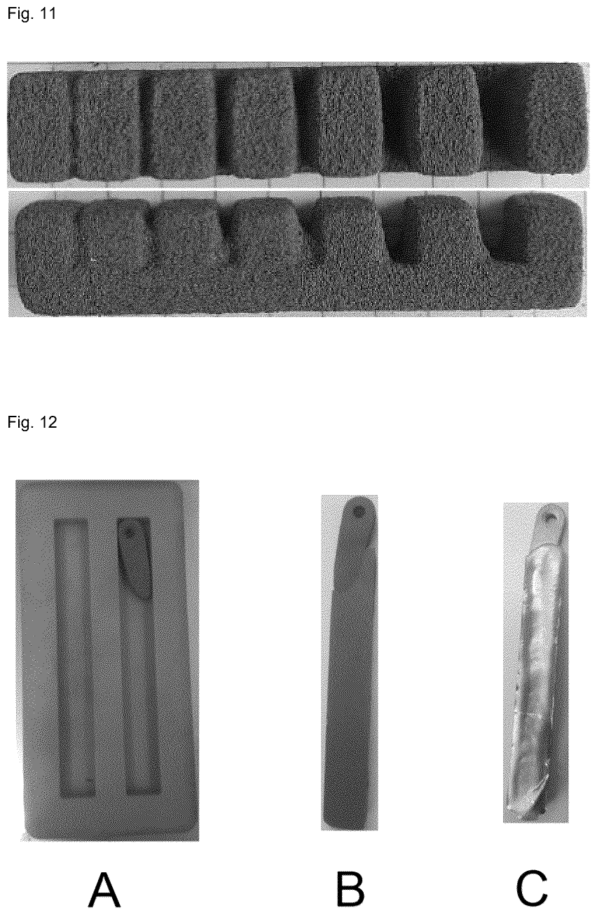

FIG. 11 depicts the notched specimen in side view and top view obtained from the feedstock compound according to table 2, 3-F.

FIG. 12 depicts a 3D-printed oblong first green part in a silicone mold (FIG. 12 A) and an integral part produced by overcasting the oblong first green part with molten feedstock compound (FIG. 12 B).

### EXAMPLES

### Methods

### Dynamic Viscoelasticity Measurements

### Determination of Storage Modulus and Loss Modulus

The dynamic viscoelasticity measurements to determine storage modulus and loss modulus were performed in accordance with DIN 53019-4:2016-10 using a NETZSCH Kinexus Pro+ device with a Peltier temperature-controlled measuring system. The measurements were performed with a plate-plate geometry with a diameter of 40 mm and a frequency of 1 Hz in oscillation mode. The measuring gap was 0.15 mm. For carrying out the measurement, the geometry was heated up to 110° C. (in example 2-B of table 3a: 160° C., in example 3-B of table 3a: 140° C.) and the sample was placed on the hot lower plate. First, it was cooled from 110° C. (140° C., 160° C.) to 60° C., then heated to 110° C. (140° C., 160° C.), each with a cooling and heating rate of 1 K/min. In the cooling ramp, the measurement was started in deformation controlled mode with a constant deformation γ=0.1%. After reaching a trigger point, the measurement was switched to shear stress controlled mode with a constant shear stress (σ=100 Pa for the binder, σ=700 Pa for the feedstock compound). In the heating ramp, the measurement was started in shear stress controlled mode with a constant shear stress of σ=300 Pa. After reaching a trigger point, the measurement was switched to deformation controlled mode with a constant deformation γ=0.1%. In the heating ramp, the trigger point was for a deformation γ=0.1%, except for binder 4-B where the trigger point was 75° C.

### Determination of Binder and Feedstock Viscosity

The dynamic viscoelasticity measurements to determine the viscosity were performed in accordance with EN ISO 3219:1994 using a NETZSCH Kinexus Pro+ device with a Peltier temperature-controlled measuring system. The measurements were performed with a plate-plate geometry with a diameter of 40 mm. The measuring gap was 0.15 mm. The measurements were performed isothermal at the following temperatures: T_{cross}+20 K, 100° C. and at 130° C. Different shear rates between 0.01 and 100 s⁻¹ were applied to determine the viscosity at different shear rates. The measurements were carried out in the range of the steady state flow. The steady state is an indicator for a time-independent flow. A purely viscous flow leads to a steady state of 1. Viscosity values determined outside the time-independent flow are not reliable. Values at a steady state below 0.90 or above 1.10, preferably below 0.95 or above 1.05, more preferably below 0.97 or above 1.03 is assumed to be not fully reliable anymore. In case of doubt, the measurement has to be repeated or another suitable measuring setup like different plate diameter, plate-cone geometry or concentrical cylinder geometry has to be selected, which are known per se.

### DSC Measurements

The DSC measurements were performed using a NETZSCH DSC 214 Polyma device. The sample was prepared in an aluminum Concavus pan (crucible) from NETZSCH with perforated lid. For this purpose, a sample is heated in a first heat ramp from −20° C. to 160° C. (in examples 2-B and 3-B of table 3a: 180° C.), cooled to −20° C. afterwards and finally heated again in a second heat ramp from −20° C. to 160° C. (180° C.), each with a heating and cooling rate of 10 K/min. Measurement were performed with nitrogen in quality 5.0 as purging gas with a gas flow of 40 mL/min.

### Production Examples

Binder components 1-B to 5-B were produced according to table 1. Feedstock compounds 1-F to 5-F of binder components 1-B to 5-B were produced according to table 2. Melt peak temperatures T_{P}, intersection/“cross-over”-temperatures T_{cross} and melting enthalpies are shown in tables 3a and 3b.

TABLE 1
Binder components 1-B to 5-B; vol.-% relative the
total volume of the binder component (b).

| | | (b-i) | | (b-ii) |
|---|---|---|---|---|
| # | material (b-i) | [vol.-%] | material (b-ii) | [vol.-%] |
| 1-B | Griltex 2439 A ^{[1]} | 27 | Loxiol 2472 ^{[2]} | 69 |
| | | | Loxiol G20 ^{[3]} | 4 |
| 2-B* | Griltex 1796A ^{[4]} | 27 | Loxiol 2472 ^{[2]} | 69 |
| | | | Loxiol G20 ^{[3]} | 4 |
| 3-B* | Orgasol 3502 D ^{[5]} | 27 | Loxiol 2472 ^{[2]} | 69 |
| | | | Loxiol G20 ^{[3]} | 4 |
| 4-B | Deurex E 06 K ^{[6]} | 30 | Deurex A 27 P ^{[7]} | 70 |
| 5-B | Griltex 2439 A ^{[1]} | 27 | Loxiol 2472 ^{[2]} | 73 |

^{[1]} copolyamide having a DSC melting range of 115 to 125° C., available from EMS-CHEMIE HOLDING AG
^{[2]} 4-hydroxybenzoic behenylester available from Emery Oleochemicals GmbH
^{[3]} stearic acid available from Emery Oleochemicals GmbH
^{[4]} copolyamide having a DSC melting range of 150 to 160° C., available from EMS-CHEMIE HOLDING AG
^{[5]} copolyamide available from Arkema
^{[6]} polyethylene-wax available from Deurex AG
^{[7]} oleamide available from Deurex AG
* comparative example.

TABLE 2
Feedstock compounds 1-F to 5-F (vol.-% relative the
total volume of the particulate feedstock compound).

| | | amount (a) | binder comp. (b) | amount (b) |
|---|---|---|---|---|
| # | metal (a) | [vol.-%] | (# in table 1) | [vol.-%] |
| 1-F | stainless steel 316 L ^{[1]} | 62 | 1-B | 38 |
| 2-F* | stainless steel 316 L ^{[1]} | 62 | 2-B* | 38 |
| 3-F* | stainless steel 316 L ^{[1]} | 62 | 3-B* | 38 |
| 4-F | stainless steel 316 L ^{[1]} | 65 | 4-B | 35 |
| 5-F | stainless steel 316 L ^{[1]} | 62 | 5-B | 38 |

^{[1]} gas atomized, particle size 90%: 22 μm, available from Sandvik Osprey Ltd.
*comparative example.

TABLE 3a
Melt peak temperatures T_{P} and intersection temperatures T_{cross}.

| | | T_{cross} | T_{cross} | [T_{cross} − T_{P}] | [T_{cross} − T_{P}] |
|---|---|---|---|---|---|
| | T_{P} | (binder) | (feedstock) | (binder) | (feedstock) |
| # | [° C.] | [° C.] | [° C.] | [° C.] | [° C.] |
| 1-B | 56.0 | 89.0 | 90.0 | 33.0 | 34.0 |
| 2-B* | 57.1 | 143.6 | 145.6 | 86.5 | 88.5 |
| 3-B* | 52.2 | 127.7 | 135.4 | 75.5 | 83.2 |
| 4-B | 73.7 | 84.7 | 82.0 | 10.9 | 8.3 |
| 5-B | 57.1 | 90.1 | 95.7 | 33.0 | 38.6 |

*comparative example.

TABLE 3b
Melting enthalpies of binder components 1-B to 4-B of table 1.

| | | | total | melting enthalpy | | melting enthalpy | | melting enthalpy | |
|---|---|---|---|---|---|---|---|---|---|
| | | | melting | between Tᵢₙᵢₜ and | | between Tᵢₙᵢₜ and | | between Tᵢₙᵢₜ and | |
| | T_{P} | Tᵢₙᵢₜ | enthalpy ^{[1]} | [T_{P} + 15 K] | | [T_{P} + 20 K] | | [T_{P} + 25 K] | |
| # | [° C.] | [° C.] | [J/g] | [J/g] | [%] | [J/g] | [%] | [J/g] | [%] |
| 1-B | 56.0 | 12.9 | 85.2 | 83.7 | 98.2 | 83.9 | 98.5 | 84.4 | 99.1 |
| 2-B* | 57.1 | 13.3 | 81.1 | 74.5 | 91.9 | 74.4 | 91.8 | 74.5 | 91.9 |
| 3-B* | 52.2 | 13.0 | 72.7 | 68.0 | 93.5 | 67.9 | 93.5 | 68.0 | 93.6 |
| 4-B | 73.3 | 25.3 | 131.4 | 129.0 | 98.2 | 130.2 | 99.1 | 130.9 | 99.6 |
| 5-B | 57.1 | 14.2 | 83.2 | 82.0 | 98.6 | 82.3 | 98.9 | 82.9 | 99.6 |

^{[1]} integral measured by DSC between Tᵢₙᵢₜ and complete melting.
*comparative example.

### Manufacture of Green Parts

### Laser Additive Manufacturing

Cylindrical testing specimen were produced by a laser additive manufacturing process using a Formiga P110 (available from EOS GmbH). The feedstock compounds 1-F to 5-F of table 2 were used as starting materials.

For the feedstock compounds 1-F to 3-F, the laser output was 25 W at a laser speed of 4450 mm/s and the powder bed surface temperature was 60° C. The hatch spacing was varied (0.13 mm vs. 0.07 mm) resulting in a different energy input: A hatch spacing of 0.13 mm resulted in an energy input of 42.3 mJ/mm²; a hatch spacing of 0.07 mm resulted in an energy input of 78.5 mJ/mm².

For the feedstock compound 4-F, the hatch spacing was 0.13 mm at a laser speed of 3000 mm/s and the powder bed surface temperature was 60° C. The laser output was varied (20 W vs. 25 W) resulting in a different energy input: A laser output of 25 W resulted in an energy input of 64.1 mJ/mm²; a laser output of 20 W resulted in an energy input of 51.3 mJ/mm².

The feedstock compounds 1-F to 3-F of table 2 were used as starting materials for producing notched specimen by a laser additive manufacturing process using a Formiga P110 as described above (see “cylindrical testing specimen”). Herein, the term “notched specimen” denotes a rectangular solid which comprises one or more notches, wherein the notches may have different widths. Such notched specimen are depicted in side view and top view in FIGS. 9 to 11.

In FIG. 9, feedstock compound 1-F was used as starting material at a laser output of 25 W, a laser speed of 4450 mm/s and a hatch spacing of 0.13 mm resulting in an energy input of 42.3 mJ/mm².

In FIG. 10, feedstock compound 2-F was used as starting material at a laser output of 25 W, a laser speed of 4450 mm/s and a hatch spacing of 0.07 mm resulting in an energy input of 78.5 mJ/mm².

In FIG. 11, feedstock compound 3-F was used as starting material at a laser output of 25 W, a laser speed of 4450 mm/s and a hatch spacing of 0.07 mm resulting in an energy input of 78.5 mJ/mm².

The production of such notched specimen aimed at obtaining specimen, i.e. parts, of high density with, at the same time, high representation of the geometry of the aimed part and little caking of the particulate feedstock compound, preferably at low laser energy input. The results are depicted in FIGS. 9 to 11: Solely the notched specimen depicted in FIG. 9 provides high density, high representation of the geometry and little caking at low laser energy input of 42.3 mJ/mm². Contrarily, the notched specimens in FIGS. 10 and 11 are less dense and/or the notches are less properly shaped due to caking at an energy input of 78.5 mJ/mm².

### Molding Process

Further testing specimen were prepared by a molding process using feedstock compounds 1-F, 2-F, 3-F and 5-F. For performing the molding process, a silicone mold having a cuboid cavity of 80×10×5 mm was prepared and pre-heated to a temperature of 60° C. in an oven. The feedstock compound to be investigated was molten at a temperature of 210° C. (2-F, 3-F, 5-F) or 170° C. (1-F) using a hot glue gun from “REKA Klebetechnik” and introduced into the cuboid cavity of the pre-heated mold by applying a pressure of 6 bar for pressing the feedstock compound out of the hot glue gun via an open nozzle having a diameter of 4 mm. After solidification of the molten feedstock compound, the resulting testing specimen was taken out of the mold. In order to obtain testing specimen having uniform surface properties, protruding feedstock material was grinded off using sanding paper. The testing specimen made from feedstock compound 1-F is depicted in FIG. 8 A; the testing specimen made from feedstock compound 2-F is depicted in FIG. 8 B; the testing specimen made from feedstock compound 3-F is depicted in FIG. 8 C; the testing specimen made from feedstock compound 5-F is depicted in FIG. 8 D. In each case, front view and back view are shown.

### Overcasting Process

Feedstock compound 1-F was used to produce an oblong first green part which was then overcast with molten feedstock compound 1-F. The oblong first green part was produced via 3D-printing using feedstock compound 1-F as described above and placed in a silicone mold having a cuboid cavity of 80×10×5 mm, see FIG. 12 A. The mold containing the oblong first green part was pre-heated to a temperature of 60° C. in an oven. Then, feedstock compound 1-F was molten at a temperature of 170° C. using a hot glue gun from “REKA Klebetechnik” and introduced into the cuboid cavity of the pre-heated mold by applying a pressure of 6 bar for pressing the feedstock compound out of the hot glue gun via an open nozzle having a diameter of 4 mm. After solidification, the resulting integral part was taken out of the mold. A picture of the integral part is depicted in FIG. 12 B; the sintered integral part is depicted in FIG. 12 C.

### Manufacture of Sintered Parts

Tensile tests according to DIN EN ISO 22068 were performed with tensile test pieces. Said tensile test pieces were additively manufactured using feedstock compound 1-F according to table 2 with a Formiga P110 as described above obtaining a green part. Said green part was then subjected to a solvent debinding step and a sintering step. For solvent debinding, the green part of feedstock compound 1-F was dipped into acetone at a temperature of 40° C. for 16 h. Sintering was carried out in a cycle with a heating and cooling rate of 5 K/min, holding times of 2 h at 380° C., of 1 h at 600° C., of 30 min at 1100° C. and of 2 h at a final sintering temperature of 1380° C. Five tensile tests were performed according to DIN EN ISO 22068; the results are shown in table 4.

TABLE 4
Tensile tests 1-T to 5-T.

| | S₀ ^{[1]} | E ^{[2]} | Rp_{0.2} ^{[3]} | Rₘ ^{[4]} | Fₘₐₓ ^{[5]} | A ^{[6]} | A* ^{[7]} | Z* ^{[8]} |
|---|---|---|---|---|---|---|---|---|
| # | [mm²] | [GPa] | [MPa] | [MPa] | [KN] | [%] | [%] | [%] |
| 1-T | 20.4 | 105.7 | 227.3 | 556.3 | 11.4 | 45.9 | 46.4 | 35.4 |
| 2-T | 22.1 | 130.7 | 214.3 | 513.7 | 11.3 | 39.6 | 40.4 | 27.9 |
| 3-T | 20.0 | 127.7 | 237.4 | 573.5 | 11.5 | 50.4 | 50.0 | 43.4 |
| 4-T | 20.9 | 142.1 | 228.2 | 557.3 | 11.7 | 50.8 | 51.6 | 42.9 |
| 5-T | 21.2 | 147.0 | 213.6 | 535.8 | 11.4 | 50.3 | 51.2 | 36.3 |

^{[1]} Cross-sectional area
^{[2]} E-modulus
^{[3]} Rp_{0.2} yield strength
^{[4]} Tensile strength
^{[5]} Maximum strength (global)
^{[6]} Elongation at break
^{[7]} Elongation at break (manually)
^{[8]} Fracture constriction (manually)

The rheometer measurements were performed for determination of viscosity in accordance with EN ISO 3219:1994 using a Kinexus rheometer (available from NETZSCH).

Tables 5 to 7 show the viscosity values of binder components 1-B to 4-B and feedstock compounds 1-F to 4-F determined at a temperature of 100° C., 130° C. or at T_{cross}+20 K.

TABLE 5
Viscosity values of binder components 1-B to 4-B and
feedstock compounds 1-F to 4-F at 130° C.

| | viscosity | viscosity | viscosity | viscosity |
|---|---|---|---|---|
| | at 0.1 s⁻¹ | at 1 s⁻¹ | at 10 s⁻¹ | at 100 s⁻¹ |
| # | [Pa · s] | [Pa · s] | [Pa · s] | [Pa · s] |
| 1-B | n.d. ^{[0]} | 2.369 | 2.241 | 2.132 |
| 2-B* | n.d. ^{[1]} | n.d. ^{[1]} | n.d. ^{[1]} | n.d. ^{[1]} |
| 3-B* | n.d. ^{[1]} | n.d. ^{[1]} | n.d. ^{[1]} | n.d. ^{[1]} |
| 4-B | 0.040 | 0.008 | 0.004 | 0.004 |
| 5-B | n.d. ^{[2]} | n.d. ^{[2]} | n.d. ^{[2]} | n.d. ^{[2]} |
| 1-F | 333.6 | 102.7 | 65.93 | n.d. ^{[0]} |
| 2-F* | n.d. ^{[1]} | n.d. ^{[1]} | n.d. ^{[1]} | n.d. ^{[1]} |
| 3-F* | n.d. ^{[1]} | n.d. ^{[1]} | n.d. ^{[1]} | n.d. ^{[1]} |
| 4-F | 0.416 | 0.488 | 1.155 | 1.055 |
| 5-F | n.d. ^{[2]} | n.d. ^{[2]} | n.d. ^{[2]} | n.d. ^{[2]} |

^{[0]} not determined; measured viscosity value outside steady state flow.
^{[1]} not determined; melting point higher than 130° C.
[^{2]} not determined.
*comparative example.

TABLE 6
Viscosity values of binder components 1-B to 4-B and
feedstock compounds 1-F to 4-F at T_{cross} + 20K.

| | T_{cross} + | viscosity | viscosity | viscosity | viscosity |
|---|---|---|---|---|---|
| | 20 K | at 0.1 s⁻¹ | at 1 s⁻¹ | at 10 s⁻¹ | at 100 s⁻¹ |
| # | [° C.] | [Pa · s] | [Pa · s] | [Pa · s] | [Pa · s] |
| 1-B | 110 | 3.762 | 3.463 | 3.203 | 3.095 |
| 2-B* | 160 | 2.195 | 1.658 | 1.272 | 1.124 |
| 3-B* | 148 | 27.96 | 18.80 | 10.43 | 9.027 |
| 4-B | 100 | 0.298 | 0.126 | 0.042 | 0.015 |
| 5-B | 110 | n.d. ^{[0]} | n.d. ^{[0]} | n.d. ^{[0]} | n.d. ^{[0]} |
| 1-F | 110 | n.d. ^{[1]} | 179.2 | 116.7 | 15.80 |
| 2-F* | 160 | 237.2 | 43.53 | 8.684 | 0.095 |
| 3-F* | 148 | 1210 | 252.5 | 2.618 | 0.009 |
| 4-F | 100 | 9.088 | 8.679 | 5.474 | 2.945 |
| 5-F | 116 | n.d. ^{[0]} | n.d. ^{[0]} | n.d. ^{[0]} | n.d. ^{[0]} |

* comparative example.
^{[0]} not determined.
^{[1]} not determined; measured viscosity value outside steady state flow.

TABLE 7
Viscosity values of binder components 1-B to 4-B and
feedstock compounds 1-F to 4-F at 100° C.

| | viscosity | viscosity | viscosity | viscosity |
|---|---|---|---|---|
| | at 0.1 s⁻¹ | at 1 s⁻¹ | at 10 s⁻¹ | at 100 s⁻¹ |
| # | [Pa · s] | [Pa · s] | [Pa · s] | [Pa · s] |
| 1-B | 6.247 | 5.654 | 5.312 | 5.121 |
| 2-B* | n.d. ^{[1]} | n.d. ^{[1]} | n.d. ^{[1]} | n.d. ^{[1]} |
| 3-B* | n.d. ^{[1]} | n.d. ^{[1]} | n.d. ^{[1]} | n.d. ^{[1]} |
| 4-B | 0.298 | 0.126 | 0.042 | 0.015 |
| 5-B | n.d. ^{[2]} | n.d. ^{[2]} | n.d. ^{[2]} | n.d. ^{[2]} |
| 1-F | 448.2 | 257.6 | 159.0 | n.d. ^{[3]} |
| 2-F* | n.d. ^{[1]} | n.d. ^{[1]} | n.d. ^{[1]} | n.d. ^{[1]} |
| 3-F* | n.d. ^{[1]} | n.d. ^{[1]} | n.d. ^{[1]} | n.d. ^{[1]} |
| 4-F | 9.088 | 8.679 | 5.474 | 2.945 |
| 5-F | n.d. ^{[2]} | n.d. ^{[2]} | n.d. ^{[2]} | n.d. ^{[2]} |

^{[1]} not determined; melting point higher than 100° C.
^{[2]} not determined.
^{[3]} not determined; measured viscosity value outside steady state flow.
* comparative example.

### Further Examples

TABLE 8
Binder components 6-B to 27-B; vol.-% relative the
total volume of the binder component (b).

| | | (b-i) | | (b-ii) |
|---|---|---|---|---|
| # | material (b-i) | [vol.-%] | material (b-ii) | [vol.-%] |
| 6-B | Technovit 9100 | 20 | Loxiol 2472 ^{[2]} | 65 |
| | PMMA powder ^{[1]} | | Loxiol G20 ^{[3]} | 15 |
| 7-B | Jowat 256.10 ^{[4]} | 30 | Deurex A 27 P ^{[7]} | 67 |
| | | | Licocene 1332 TP ^{[5]} | 3 |
| 8-B | Jowat 280.10 ^{[8]} | 20 | Loxiol 2472 ^{[2]} | 57 |
| | | | Loxiol G20 ^{[3]} | 20 |
| | | | Licocene 1332 TP ^{[5]} | 3 |
| 9-B | Jowat 280.10 ^{[8]} | 20 | Deurex A 27 P ^{[7]} | 77 |
| | | | Licocene 1332 TP ^{[5]} | 3 |
| 10-B | Deurex E 06 K ^{[6]} | 30 | Loxiol G20 ^{[3]} | 70 |
| 11-B | VISCOWAX 353 ^{[9]} | 30 | Loxiol G20 ^{[3]} | 70 |
| 12-B | VISCOWAX 353 ^{[9]} | 30 | Deurex A 27 P ^{[7]} | 70 |
| 13-B | Deurex E 06 K ^{[6]} | 30 | 1-octadecanol ^{[10]} | 70 |
| 14-B | Deurex E 06 K ^{[6]} | 30 | monostearin ^{[11]} | 70 |
| 15-B | Griltex 2439 A ^{[12]} | 30 | N-ethyltoluene-4- | 55 |
| | | | sulfonamide ^{[13]} | |
| | | | Deurex A 27 P ^{[7]} | 10 |
| | | | Loxiol G20 ^{[3]} | 5 |
| 16-B | polycaprolactone ^{[14]} | 20 | Loxiol 2472 ^{[2]} | 60 |
| | | | Loxiol G20 ^{[3]} | 20 |
| 17-B | polycaprolactone ^{[14]} | 20 | monostearin ^{[11]} | 80 |
| 18-B | polycaprolactone ^{[14]} | 20 | N-ethyltoluene-4- | 75 |
| | | | sulfonamide ^{[13]} | |
| | | | Loxiol G20 ^{[3]} | 5 |
| 19-B | polycaprolactone ^{[14]} | 20 | Deurex A 27 P ^{[7]} | 77 |
| | | | Licocene 1332 TP ^{[5]} | 3 |
| 20-B | polycaprolactone ^{[14]} | 20 | 1-octadecanol ^{[10]} | 80 |
| 21-B | VISCOWAX 353 ^{[9]} | 30 | 1-octadecanol ^{[10]} | 70 |
| 22-B | VISCOWAX 353 ^{[9]} | 30 | monostearin ^{[11]} | 70 |
| 23-B | Technovit 9100 | 20 | N-ethyltoluene-4- | 75 |
| | PMMA powder ^{[1]} | | sulfonamide ^{[13]} | 5 |
| | | | Loxiol G20 ^{[3]} | |
| 24-B | EnBA EN 33901 ^{[15]} | 20 | Deurex A 27 P ^{[7]} | 77 |
| | | | Licocene 1332 TP ^{[5]} | 3 |
| 25-B | EnBA EN 33901 ^{[15]} | 20 | monostearin ^{[11]} | 80 |
| 26-B | polycaprolactone ^{[14]} | 20 | diphenyl | 75 |
| | | | phthalate ^{[17]} | |
| | | | Loxiol G20 ^{[3]} | 5 |
| 27-B | Riteflex 425 ^{[16]} | 20 | monostearin ^{[11]} | 80 |

^{[1]} polymethylmethacrylat available at MORPHISTO GmbH
^{[2]} 4-hydroxybenzoic behenylester available from Emery Oleochemicals GmbH
^{[3]} stearic acid available from Emery Oleochemicals GmbH
^{[4]} copolymer based on different polyolefins available from Jowat AG
^{[5]} propylene-ethylene-maleic anhydride copolymer available from Clariant International Ltd
^{[6]} polyethylene-wax available from Deurex AG
^{[7]} oleamide available from Deurex AG
^{[8]} copolymer based on ethylene and vinyl acetate available from Jowat AG
^{[9]} wax based on ethylene and vinyl acetate available from Innospec Leuna GmbH
^{[10]} 1-octadecanol available from Sigma-Aldrich
^{[11]} monostearin (glycerol 2-stearate) available TCI Deutschland GmbH
^{[12]} copolyamide having a DSC melting range of 115 to 125° C., available from EMS-CHEMIE HOLDING AG
^{[13]} N-ethyltoluene-4-sulfonamide available from Sigma-Aldrich
^{[14]} polycaprolactone available from Materialix
^{[15]} copolymer based on ethylene and n-butyl acrylate available from ExxonMobil
^{[16]} polyester-based thermoplastic elastomer available from Celanese GmbH
^{[17]} diphenyl phthalate available from Sigma-Aldrich

TABLE 9
Melt peak temperatures T_{P} and intersection temperatures T_{cross}.

| | | T_{cross} | [T_{cross} − T_{P}] |
|---|---|---|---|
| | | (binder) | (binder) |
| # | T_{P} | [° C.] | [° C.] |
| 6-B | 63.6 | 74.4 | 10.8 |
| 7-B | 76.0 | 114.6 | 38.6 |
| 8-B | 62.0 | 60.9 | −1.1 |
| 9-B | 76.9 | 72.0 | −4.9 |
| 10-B | 57.2 | 76.0 | 18.8 |
| 11-B | 58.1 | 54.1 | −4.0 |
| 12-B | 77.0 | 71.8 | −5.2 |
| 13-B | 58.7 | 75.4 | 16.7 |
| 14-B | 64.1 | 67.3 | 3.2 |
| 15-B | 30.6 | 62.5 | 31.9 |
| 16-B | 51.2 | 52.9 | 1.7 |
| 17-B | 69.5 | 61.6 | −7.9 |
| 18-B | 50.4 | 48.1 | −2.3 |
| 19-B | 77.6 | 73.5 | −4.1 |
| 20-B | 61.7 | 58.9 | −2.8 |
| 21-B | 59.8 | 72.9 | 13.1 |
| 22-B | 68.8 | 65.5 | −3.3 |
| 23-B | 53.6 | 36.9 | −16.7 |
| 24-B | 76.9 | 73.9 | −3.0 |
| 25-B | 69.3 | 64.6 | −4.7 |
| 26-B | 52.1 | 35.1 | −17.0 |
| 27-B | 68.8 | 67.5 | −1.3 |

TABLE 10
Viscosity values of binder components 6-B to 27-B at 130° C.

| | viscosity | viscosity | viscosity | viscosity |
|---|---|---|---|---|
| | at 0.1 s⁻¹ | at 1 s⁻¹ | at 10 s⁻¹ | at 100 s⁻¹ |
| # | [Pa · s] | [Pa · s] | [Pa · s] | [Pa · s] |
| 6-B | 5.601 | 4.142 | 3.762 | n.d. ^{[1]} |
| 7-B | n.d. ^{[1]} | n.d. ^{[1]} | 0.006 | 0.005 |
| 8-B | n.d. ^{[1]} | 0.426 | 0.362 | 0.314 |
| 9-B | n.d. ^{[1]} | 0.149 | 0.158 | 0.146 |
| 10-B | n.d. ^{[1]} | n.d. ^{[1]} | 0.002 | 0.002 |
| 11-B | n.d. ^{[1]} | 0.032 | 0.030 | 0.030 |
| 12-B | n.d. ^{[1]} | 0.029 | 0.028 | 0.028 |
| 13-B | n.d. ^{[1]} | n.d. ^{[1]} | 0.002 | 0.002 |
| 14-B | 0.016 | 0.006 | 0.005 | 0.005 |
| 15-B | n.d. ^{[1]} | 0.306 | 0.309 | 0.311 |
| 16-B | 1.682 | 1.538 | 1.412 | 1.295 |
| 17-B | n.d. ^{[1]} | n.d. ^{[1]} | n.d. ^{[1]} | n.d. ^{[1]} |
| 18-B | 2.315 | 2.360 | 2.371 | 2.349 |
| 19-B | 0.521 | 0.433 | n.d. ^{[1]} | n.d. ^{[1]} |
| 20-B | 1.763 | 1.371 | 1.156 | 0.728 |
| 21-B | n.d. ^{[1]} | 0.018 | 0.019 | 0.020 |
| 22-B | n.d. ^{[1]} | 0.036 | 0.037 | 0.038 |
| 23-B | 2.262 | 2.242 | 2.282 | 2.168 |
| 24-B | 0.076 | 0.082 | 0.083 | 0.085 |
| 25-B | 0.053 | 0.065 | 0.067 | 0.072 |
| 26-B | 5.513 | 5.600 | 5.575 | 5.359 |
| 27-B | 4.491 | 4.123 | 3.569 | 2.895 |

^{[1]} not determined; measured viscosity value outside steady state flow.

TABLE 11
Viscosity values of binder components 6-B to 27-B at 100° C.

| | viscosity | viscosity | viscosity | viscosity |
|---|---|---|---|---|
| | at 0.1 s⁻¹ | at 1 s⁻¹ | at 10 s⁻¹ | at 100 s⁻¹ |
| # | [Pa · s] | [Pa · s] | [Pa · s] | [Pa · s] |
| 6-B | 28.89 | 27.63 | 25.98 | n.d. ^{[1]} |
| 7-B | n.d. ^{[1]} | 1.441 | 0.370 | 0.113 |
| 8-B | 0.901 | 0.941 | 1.231 | 0.963 |
| 9-B | n.d. ^{[1]} | 0.395 | 0.418 | 0.378 |
| 10-B | n.d. ^{[1]} | n.d. ^{[1]} | 0.009 | 0.006 |
| 11-B | n.d. ^{[1]} | 0.061 | 0.058 | 0.058 |
| 12-B | n.d. ^{[1]} | 0.060 | 0.060 | 0.060 |
| 13-B | n.d. ^{[1]} | n.d. ^{[1]} | 0.005 | 0.004 |
| 14-B | 0.106 | 0.049 | 0.021 | 0.013 |
| 15-B | 0.965 | 0.962 | 0.966 | 0.972 |
| 16-B | 6.378 | 5.754 | 5.424 | 5.181 |
| 17-B | 1.858 | 0.400 | 0.073 | n.d. ^{[1]} |
| 18-B | 6.795 | 4.887 | 5.139 | 5.143 |
| 19-B | n.d. ^{[1]} | n.d. ^{[1]} | n.d. ^{[1]} | n.d. ^{[1]} |
| 20-B | 8.538 | 2.907 | 1.922 | n.d. ^{[1]} |
| 21-B | n.d. ^{[1]} | 0.036 | 0.037 | 0.038 |
| 22-B | n.d. ^{[1]} | 0.082 | 0.082 | 0.083 |
| 23-B | n.d. ^{[1]} | 7.592 | 6.210 | 5.580 |
| 24-B | 0.191 | 0.189 | 0.190 | 0.193 |
| 25-B | 0.103 | 0.063 | 0.061 | n.d. [1] |
| 26-B | 15.890 | 13.330 | 13.160 | 12.240 |
| 27-B | n.d. ^{[1]} | n.d. ^{[1]} | n.d. ^{[1]} | n.d. ^{[1]} |

^{[1]} not determined; measured viscosity value outside steady state flow.

1. A binder component for a feedstock compound for use in a shaping and sintering process comprising, based on the total volume of the binder component b),
b-i) 3 to 70% by volume of at least one thermoplastic material selected from polyesters, polyolefins, polyolefin waxes, polyamides, polyacrylates or mixtures thereof,
b-ii) 30 to 97% by volume of at least one wax-type material selected from polar waxes,
wherein the thermoplastic material and the wax-type material differ in
solubility in a solvent,
wherein the thermoplastic material is less soluble than the wax-type material,
wherein T_{cross} is higher by not more than 60 K, preferably by not more than 50 K, more preferably by not more than 45 K, most preferably by not more than 40 K, in particular by not more than 35 K, than T_{P}, wherein
T_{P} is the DSC melt peak temperature of the binder component b), and
T_{cross} is the temperature at the intersection between the storage modulus G′ curve and the loss modulus G″ curve in a dynamic viscoelasticity measurement of the binder component b).

2. The binder component of claim 1, exhibiting a percentage of melting enthalpy measured by DSC between Tᵢₙᵢₜ and [T_{P}+25 K], of at least 94% of the total melting enthalpy, wherein Tᵢₙᵢₜ is the initial melting temperature.

3. The binder component of claim 1, wherein T_{P} is below 180° C.

4. The binder component of claim 1, exhibiting a viscosity, as determined at a temperature of 130° C.; and at a shear rate of 1 s⁻¹ of below 6 Pa·s.

5. The binder component of claim 1, exhibiting a viscosity, as determined at a temperature of 110° C.; and at a shear rate of 1 s⁻¹, of below 8 Pa·s.

6. The binder component of claim 1, exhibiting a viscosity, as determined at a temperature of 100° C.; and at a shear rate of 1 s⁻¹ of below 10 Pa·s.

7. (canceled)

8. The binder component of claim 1, wherein the amount of the thermoplastic material b-i) is in the range of about 5 to 60% by volume, based on the total volume of the binder component b), and/or
the amount of the wax-type material b-ii) is in the range of about to 95% by volume, based on the total volume of the binder component b).

9. The binder component of claim 1, wherein b-i) is selected from polycaprolactone, polylactides, polyglycolides, poly(hydroxyl alkanoates) phthalates, polycarbonates, copolyesters; polyethylene, polypropylene, polyolefinic copolymers, polyolefinic copolymers with non-olefinic monomers, modified polyolefins; homopolymers of propylene or higher 1-olefins, copolymers of propylene with ethylene or with higher 1-olefins or their copolymers with one another; polyamide 12, copolyamides; polymethylmethacrylates; or mixtures thereof.

10. The binder component of claim 1, wherein b-ii) is selected from polyolefinic waxes, ester-type waxes, amide waxes, higher organic acids, higher or polyhydric alcohols, polyethylene glycol, or mixtures thereof.

11. The binder component of claim 10, wherein b-ii) is selected from aromatic esters, aromatic sulfonamides or mixtures thereof.

12. The binder component of claim 1, incorporating a combination of the thermoplastic material b-i) and the wax-type material b-ii) selected from the following table:

| | |
|---|---|
| [symbol] thermoplastic [symbol] | [symbol] [symbol] [symbol] |
| material (b-i) | wax-type material (b-ii) |
| polyamide [symbol] [symbol] | ester-type waxes [symbol] |
| [symbol] | [symbol] [symbol] |
| | [symbol] |
| | optionally in combination with stearic |
| | acid |
| | sulfonamide [symbol] [symbol] |
| | [symbol] |
| | amide wax [symbol] [symbol] |
| | [symbol] |
| | optionally in combination with stearic |
| | acid |
| polyethylene wax [symbol] | amide wax [symbol] [symbol] |
| optionally with propylene-ethylene | [symbol] |
| copolymer [symbol] | optionally in combination with stearic |
| | acid |
| polyethylene wax [symbol] | stearic acid |
| | higher alcohols [symbol] |
| | esters of organic acids [symbol] |
| | [symbol] [symbol] |
| polypropylene wax [symbol] | amide wax [symbol] [symbol] |
| | [symbol] |
| | optionally in combination with stearic |
| | acid |
| polyethylene wax [symbol] | polyalkylene glycol [symbol] |
| | glycol [symbol] |
| poly(meth)acrylate [symbol] | ester-type waxes [symbol] |
| [symbol] [symbol] | [symbol] [symbol] |
| [symbol] | [symbol] |
| | optionally in combination with stearic |
| | acid |
| | sulfonamide [symbol] |
| | [symbol] |
| | optionally in combination with stearic |
| | acid |
| polyolefinic copolymer [symbol] | amide wax [symbol] [symbol] |
| [symbol] | [symbol] |
| | optionally in combination with |
| | polyolefinic copolymers with non-olefinic |
| | monomers [symbol] |
| | [symbol] [symbol] |
| | [symbol] |
| polyolefinic copolymers with non-olefinic | ester-type waxes [symbol] |
| monomers [symbol] [symbol] | [symbol] [symbol] |
| [symbol] [symbol] | [symbol] |
| | optionally in combination with stearic |
| | acid |
| | optionally in combination with |
| | polyolefinic copolymers with non-olefinic |
| | monomers [symbol] [symbol] |
| | [symbol] [symbol] |
| | [symbol] |
| | amide wax [symbol] [symbol] |
| | [symbol] |
| | optionally in combination with |
| | polyolefinic copolymers with non-olefinic |
| | monomers [symbol] [symbol] |
| | [symbol] [symbol] |
| | [symbol] |
| copolymeric wax of polyolefins [symbol] | stearic acid |
| [symbol] [symbol] | amide wax [symbol] [symbol] |
| [symbol] | [symbol] |
| | higher alcohols [symbol] |
| | esters of organic acids [symbol] |
| | [symbol] [symbol] |
| polyolefinic copolymers with non-olefinic | amide wax [symbol] [symbol] |
| monomers [symbol] | [symbol] |
| [symbol] [symbol] | optionally in combination with |
| [symbol] | polyolefinic copolymers with non-olefinic |
| | monomers [symbol] |
| | [symbol] [symbol] |
| | [symbol] |
| | esters of organic acids [symbol] |
| | [symbol] |
| polyester [symbol] | ester-type waxes [symbol] |
| | [symbol] [symbol] |
| | [symbol] |
| | optionally in combination with stearic |
| | acid |
| | esters of organic acids [symbol] |
| | [symbol] |
| | sulfonamide [symbol] |
| | [symbol] |
| | optionally in combination with stearic |
| | acid |
| | amide wax [symbol] |
| | [symbol] |
| | optionally in combination with |
| | polyolefinic copolymers with non-olefinic |
| | monomers [symbol] |
| | [symbol] [symbol] |
| | [symbol] |
| | higher alcohols [symbol] |
| | polyester [symbol] |
| | optionally in combination with stearic |
| | acid |
| polyester-based thermoplastic elastomer | esters of organic acids [symbol] |
| [symbol] | [symbol] [symbol] |

13. A particulate feedstock compound for use in a shaping and sintering process, containing
a) sinterable non-organic particles dispersed throughout the particulate feedstock compound, the sinterable non-organic particles having a particle size distribution such that at least 80% of the particles have a maximum particle size Aₘₐₓ in the range of 100 nm to 400 μm; and
b) the binder component b) of claim 1.

14. The particulate feedstock compound of claim 13, wherein the sinterable non-organic particles are selected from
a-i) metal particles selected from iron, stainless steel, steel, copper, bronze, aluminum, tungsten, molybdenum, silver, gold, platinum, titanium, nickel, cobalt, chromium, zinc, niobium, tantalum, yttrium, silicon, magnesium, calcium and combinations thereof, having a particle size distribution such that at least 85% of the particles have a maximum particle size Aₘₐₓ in the range of 500 nm to 400 μm;
a-ii) ceramic particles selected from oxides; carbides; nitrides; silicates; and combinations thereof, having a particle size distribution such that at least 85% of the particles have a maximum particle size Aₘₐₓ in the range of 200 nm to 25 μm;
a-iii) vitreous particles selected from non-oxide glasses; oxide glasses; silicate glasses; and combinations thereof, having a particle size distribution such that at least 85% of the particles have a maximum particle size Aₘₐₓ in the range of 200 nm to 25 μm;
a-iv) combinations of more than one of the sinterable non-organic particles a-i) to a-iii).

15. The particulate feedstock compound of claim 13, containing the sinterable non-organic particles (a) in an amount of about 0.70 to 0.99·ϕᵣ by volume, wherein ϕᵣ is the critical solids loading by volume.

16. The particulate feedstock compound of claim 13, wherein the amount of
the sinterable non-organic particles a) is in the range of about 20 to 90% by volume, and
the amount of the binder component b) is in the range of about 10 to 80% by volume.

17. The particulate feedstock compound of claim 13, exhibiting a viscosity, as determined at a temperature of 130° C., and a shear rate of 1 s⁻¹, of below 600 Pa·s.

18. The particulate feedstock compound of claim 13, exhibiting a viscosity, as determined at a temperature of 110° C., and a shear rate of 1 s⁻¹, of below 800 Pa·s.

19. The particulate feedstock compound of claim 13, exhibiting a viscosity, as determined at a temperature of 100° C., and a shear rate of 1 s⁻¹, of below 1000 Pa·s.

20. A process comprising the steps of:
merging a plurality of the particulate feedstock compounds according to claim 10 to obtain a green part,
partially debinding the green part by selectively removing the wax-type material b-ii) to obtain a brown part comprising the sinterable non-organic powder particles a) bound to each other by the thermoplastic material b-i), and
sintering the brown part to obtain a sintered part.

21. The process of claim 20, selected from an additive manufacturing process; an injection molding process; a pressing process; and/or a casting process.

22. A green part obtained by merging a plurality of the particulate feedstock compounds according to claim 12.
